(19) United States
(12) Patent Application Publication
(10) Pub. No.: US 2025/0070826 A1
(43) Pub. Date: Feb. 27, 2025

(54) POLARIZATION SWITCHING

(71) Applicant: Greatest Heroes Oy, Helsinki (FI)

(72) Inventor: Jukka Lempiäinen, Helsinki (FI)

(21) Appl. No.: 18/725,411

(22) PCT Filed: Jan. 24, 2023
(86) PCT No.: PCT/FI2023/050050

§ 371 Date: Jun. 28, 2024

(30) Foreign Application Priority Data
Jan. 26, 2022 (FI) 20225062
May 6, 2022 (FI) 20225394

(51) Int. Cl. H04B 7/0417; H04B 7/0456; H04B 7/06; H04B 7/10; H04W 16/28

(52) U.S. Cl. CPC H04B 7/0417; H04B 7/0469; H04B 7/0632; H04B 7/10; H04W 16/28

(57) ABSTRACT

Example embodiments relate to configuration of polarization or orbital angular momentum (OAM). A method may comprise: transmitting or receiving, by an access node of a first cell with antenna(s), signal(s) to/from at least one edge area of the first cell using single-polarization or single-OAM mode communication with a first polarization or OAM mode; and transmitting or receiving, by the access node of the first cell with the antenna(s), signal(s) to/from at least one non-edge area of the first cell using multi-polarization or multi-OAM mode communication with the first polarization or OAM mode and at least a second polarization or OAM mode, wherein the second polarization or OAM mode is substantially orthogonal to the first polarization or OAM mode and configured for single-polarization or single-OAM mode communication at at least one edge area of a second cell, wherein the second cell is adjacent to the first cell.

### TECHNICAL FIELD

Various example embodiments generally relate to the field of wireless communications. Some example embodiments relate to configuration of polarization or orbital angular momentum (OAM) in a cellular radio network.

### BACKGROUND

Various wireless communication systems may be configured as a cellular radio network comprising multiple cells with respective coverage areas. Devices, such as for example user equipment (UE), and access nodes may be configured to receive and/or transmit signals with multiple polarizations, for example in order to facilitate multiple-input multiple-output (MIMO) transmission.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments improve overall data transmission capacity in a cellular communication network. This and other benefits may be achieved by the features of the independent claims. Further example embodiments are provided in the dependent claims, the description, and the drawings.

According to a first aspect, an apparatus may comprise at least one processor, and at least one memory including computer program code; the at least one memory and the computer program code configured to, with the at least one processor, cause the apparatus at least to: receive, from an access node of a first cell, an indication of a first polarization or orbital angular momentum (OAM) mode configured for single-polarization or single-OAM communication at the first cell and an indication of a second polarization or OAM mode configured for single-polarization or single-OAM communication at a second cell, wherein the second polarization or OAM mode is substantially orthogonal to the first polarization or OAM mode, and wherein the second cell is adjacent to the first cell; and select a first antenna configuration for single-polarization or single-OAM communication with the first polarization or OAM mode and transmit or receive at least one signal to/from the first cell with the first antenna configuration, or transmit an indication of the first polarization or OAM mode or the first antenna configuration to an external antenna device and transmit or receive the at least one signal to/from the first cell via the external antenna device.

According to an example embodiment of the first aspect, the indication of the second polarization or OAM mode is included in a list of polarizations or OAM modes associated with at least two of a plurality of cells.

According to an example embodiment of the first aspect, the plurality of cells are located in a substantially linear pattern, and adjacent cells of the plurality of cells are configured with substantially orthogonal polarizations or OAM modes.

According to an example embodiment of the first aspect, the at least one memory and the computer program code are further configured to, with the at least one processor, cause the apparatus to: receive, from the access node, a condition for selecting a single-polarization or single-OAM mode antenna configuration or a dual-polarization or multi-OAM antenna configuration for communication at least at the first cell, wherein the condition comprises a first threshold for received signal strength.

According to an example embodiment of the first aspect, the at least one memory and the computer program code are further configured to, with the at least one processor, cause the apparatus to: select the first antenna configuration or transmit the indication of the first polarization or OAM mode or the first antenna configuration to the external antenna device, in response to determining that received signal strength from the first cell does not exceed the first threshold; and/or select a second antenna configuration for dual-polarization or multi-OAM mode communication with the first polarization or OAM mode and the second polarization or OAM mode and transmit or receive the at least one signal to/from the first cell with the second antenna configuration, or transmit an indication of the first and second polarizations or the second antenna configuration to the external antenna device, in response to determining that the received signal strength from the first cell exceeds the first threshold.

According to an example embodiment of the first aspect, the at least one memory and the computer program code are further configured to, with the at least one processor, cause the apparatus to: switch to a third antenna configuration configured for single-polarization or single-OAM mode communication with the second polarization or OAM mode and transmit or receive at least one signal to/from the second cell with the third antenna configuration, or transmit an indication of the second polarization or OAM mode or the third antenna configuration to the external antenna device and transmit or receive the at least one signal to/from the second cell via the external antenna device.

According to an example embodiment of the first aspect, the at least one memory and the computer program code are further configured to, with the at least one processor, cause the apparatus to: switch to the third antenna configuration or transmit the indication of the second polarization or OAM mode or the third antenna configuration to the external antenna device, in response to performing a cell re-selection or a handover to the second cell.

According to an example embodiment of the first aspect, the at least one memory and the computer program code are further configured to, with the at least one processor, cause the apparatus to: determine to switch to the second antenna configuration, in response to detecting received signal strength from the first cell to decrease below or equal to a second threshold; continue transmission or reception of the at least one signal to/from the first cell with the second antenna configuration, or transmit an indication of the first and second polarizations or OAM modes or the second antenna configuration to the external antenna device to continue transmission or reception of the at least one signal to/from the first cell via the external antenna device; perform neighbour cell measurements with the second antenna configuration; and perform the cell re-selection or the handover to the second cell based on the neighbour cell measurements.

According to an example embodiment of the first aspect, the first threshold is higher than the second threshold.

According to an example embodiment of the first aspect, the at least one memory and the computer program code are further configured to, with the at least one processor, cause the apparatus to: select the first antenna configuration based on a fixed mapping between the first antenna configuration and the first polarization or OAM mode, or measure an orientation of the apparatus and select the first antenna configuration based on the orientation of the apparatus and the first polarization or OAM mode.

According to an example embodiment of the first aspect, the at least one memory and the computer program code are further configured to, with the at least one processor, cause the apparatus to: measure received signal strength from the first cell with the first antenna configuration; measure received signal strength from the first cell with the third antenna configuration; and select the first antenna configuration, in response to determining that the received signal strength measured with the first antenna configuration exceeds the received signal strength measured with the third antenna configuration.

According to an example embodiment of the first aspect, the indication of the first polarization or OAM mode, the indication of the second polarization or OAM mode, and/or the list of polarizations or OAM modes are received in system information of the first cell.

According to an example embodiment of the first aspect, the system information is received on a broadcast channel of the first cell.

According to a second aspect, a method may comprise: receiving, from an access node of a first cell, an indication of a first polarization or orbital angular momentum (OAM) mode configured for single-polarization or single-OAM communication at the first cell and an indication of a second polarization or OAM mode configured for single-polarization or single-OAM communication at a second cell, wherein the second polarization or OAM mode is substantially orthogonal to the first polarization or OAM mode, and wherein the second cell is adjacent to the first cell; and selecting a first antenna configuration for single-polarization or single-OAM communication with the first polarization or OAM mode and transmitting or receiving at least one signal to/from the first cell with the first antenna configuration, or transmitting an indication of the first polarization or OAM mode or the first antenna configuration to an external antenna device and transmitting or receiving the at least one signal to/from the first cell via the external antenna device.

According to an example embodiment of the second aspect, the indication of the second polarization or OAM mode is included in a list of polarizations or OAM modes associated with at least two of a plurality of cells.

According to an example embodiment of the second aspect, the plurality of cells are located in a substantially linear pattern, and adjacent cells of the plurality of cells are configured with substantially orthogonal polarizations or OAM modes.

According to an example embodiment of the second aspect, the method may further comprise: receiving, from the access node, a condition for selecting a single-polarization or single-OAM mode antenna configuration or a dual-polarization or multi-OAM antenna configuration for communication at least at the first cell, wherein the condition comprises a first threshold for received signal strength.

According to an example embodiment of the second aspect, the method may further comprise: selecting the first antenna configuration or transmitting the indication of the first polarization or OAM mode or the first antenna configuration to the external antenna device, in response to determining that received signal strength from the first cell does not exceed the first threshold; and/or selecting a second antenna configuration for dual-polarization or multi-OAM mode communication with the first polarization or OAM mode and the second polarization or OAM mode and transmitting or receiving the at least one signal to/from the first cell with the second antenna configuration, or transmitting an indication of the first and second polarizations or the second antenna configuration to the external antenna device, in response to determining that the received signal strength from the first cell exceeds the first threshold.

According to an example embodiment of the second aspect, the method may further comprise: switching to a third antenna configuration configured for single-polarization or single-OAM mode communication with the second polarization or OAM mode and transmitting or receiving at least one signal to/from the second cell with the third antenna configuration, or transmitting an indication of the second polarization or OAM mode or the third antenna configuration to the external antenna device and transmitting or receiving the at least one signal from the second cell via the external antenna device.

According to an example embodiment of the second aspect, the method may further comprise: switching to the third antenna configuration or transmitting the indication of the second polarization or OAM mode or the third antenna configuration to the external antenna device, in response to performing a cell re-selection or a handover to the second cell.

According to an example embodiment of the second aspect, the method may further comprise: determining to switch to the second antenna configuration, in response to detecting received signal strength from the first cell to decrease below or equal to a second threshold; continuing transmission or reception of the at least one signal to/from the first cell with the second antenna configuration, or transmitting an indication of the first and second polarizations or OAM modes or the second antenna configuration to the external antenna device to continue transmission or reception of the at least one signal from the first cell via the external antenna device; performing neighbour cell measurements with the second antenna configuration; and performing the cell re-selection or the handover to the second cell based on the neighbour cell measurements.

According to an example embodiment of the second aspect, the first threshold is higher than the second threshold.

According to an example embodiment of the second aspect, the method may further comprise: selecting the first antenna configuration based on a fixed mapping between the first antenna configuration and the first polarization or OAM mode, or measuring an orientation of the apparatus and selecting the first antenna configuration based on the orientation of the apparatus and the first polarization or OAM mode.

According to an example embodiment of the second aspect, the method may further comprise: measuring received signal strength from the first cell with the first antenna configuration; measuring received signal strength from the first cell with the third antenna configuration; and selecting the first antenna configuration, in response to determining that the received signal strength measured with the first antenna configuration exceeds the received signal strength measured with the third antenna configuration.

According to an example embodiment of the second aspect, the indication of the first polarization or OAM mode, the indication of the second polarization or OAM mode, and/or the list of polarizations or OAM modes are received in system information of the first cell.

According to an example embodiment of the second aspect, the system information is received on a broadcast channel of the first cell.

According to a third aspect a computer program or a computer program product may comprise instructions for causing an apparatus to perform at least the following: receiving, from an access node of a first cell, an indication of a first polarization or orbital angular momentum (OAM) mode configured for single-polarization or single-OAM communication at the first cell and an indication of a second polarization or OAM mode configured for single-polarization or single-OAM communication at a second cell, wherein the second polarization or OAM mode is substantially orthogonal to the first polarization or OAM mode, and wherein the second cell is adjacent to the first cell; and selecting a first antenna configuration for single-polarization or single-OAM communication with the first polarization or OAM mode and transmitting or receiving at least one signal to/from the first cell with the first antenna configuration, or transmitting an indication of the first polarization or OAM mode or the first antenna configuration to an external antenna device and transmitting or receiving the at least one signal to/from the first cell via the external antenna device. The computer program may further comprise instructions for causing the apparatus to perform any example embodiment of the method of the second aspect.

According to a fourth aspect an apparatus may comprise: means for receiving, from an access node of a first cell, an indication of a first polarization or orbital angular momentum (OAM) mode configured for single-polarization or single-OAM communication at the first cell and an indication of a second polarization or OAM mode configured for single-polarization or single-OAM communication at a second cell, wherein the second polarization or OAM mode is substantially orthogonal to the first polarization or OAM mode, and wherein the second cell is adjacent to the first cell; and means for selecting a first antenna configuration for single-polarization or single-OAM communication with the first polarization or OAM mode and means for transmitting or receiving at least one signal from the first cell with the first antenna configuration, or means for transmitting an indication of the first polarization or OAM mode or the first antenna configuration to an external antenna device and means for transmitting or receiving the at least one signal to/from the first cell via the external antenna device. The apparatus may further comprise means for performing any example embodiment of the method of the second aspect.

According to a fifth aspect, an apparatus may comprise at least one processor, and at least one memory including computer program code; the at least one memory and the computer program code configured to, with the at least one processor, cause the apparatus at least to: transmit, by an access node of a first cell, an indication of a first polarization or orbital angular momentum (OAM) mode configured for single-polarization or single-OAM mode communication at the first cell and an indication of a second polarization or OAM mode configured for single-polarization or single-OAM mode communication at a second cell, wherein the second polarization of OAM mode is substantially orthogonal to the first polarization or OAM mode, and wherein the second cell is adjacent to the first cell; select a first antenna configuration for single-polarization or single-OAM mode communication with the first polarization or OAM mode; and transmit or receive at least one signal with the first antenna configuration.

According to an example embodiment of the fifth aspect, the indication of the second polarization or OAM mode is included in a list of polarizations or OAM modes associated with at least two of plurality of cells.

According to an example embodiment of the fifth aspect, the plurality of cells are located in a substantially linear pattern, and adjacent cells of the plurality of cells are configured with substantially orthogonal polarizations or OAM modes.

According to an example embodiment of the fifth aspect, the at least one memory and the computer program code are further configured to, with the at least one processor, cause the apparatus to: select a second antenna configuration for dual-polarization or multi-OAM mode communication with the first polarization or OAM-mode and the second polarization or OAM mode, wherein the second antenna configuration comprises a second antenna tilt configured to direct the at least one signal to at least one non-edge area of the first cell, and wherein the first antenna configuration comprises a first antenna tilt configured to direct the at least one signal to at least one edge area of the first cell.

According to an example embodiment of the fifth aspect, the at least one memory and the computer program code are further configured to, with the at least one processor, cause the apparatus to: transmit the at least one signal with the second antenna configuration to the at least one non-edge area of the first cell.

According to an example embodiment of the fifth aspect, the at least one memory and the computer program code are further configured to, with the at least one processor, cause the apparatus to: transmit a condition for applying a single-polarization or single-OAM mode antenna configuration or a dual-polarization or multi-OAM mode antenna configuration for communication at least at the first cell, wherein the condition comprises a threshold for received signal strength.

According to an example embodiment of the fifth aspect, the at least one memory and the computer program code are further configured to, with the at least one processor, cause the apparatus to: select the first antenna configuration, in response to receiving, from at least one core network node, a configuration of the first polarization or OAM mode for single-polarization or single-OAM mode communication at the first cell.

According to an example embodiment of the fifth aspect, the at least one memory and the computer program code are further configured to, with the at least one processor, cause the apparatus to: transmit the indication of the second polarization or OAM mode configured for single-polarization or single-OAM mode communication at the second cell and/or the list of polarizations or OAM modes, in response to receiving a configuration of the second polarization or OAM mode for single-polarization or single-OAM mode communication at the second cell and/or the list of polarizations or OAM modes from the at least one core network node.

According to an example embodiment of the fifth aspect, the at least one memory and the computer program code are further configured to, with the at least one processor, cause the apparatus to: select the first antenna configuration based on a fixed mapping between the first antenna configuration and the first polarization or OAM mode.

According to an example embodiment of the fifth aspect, the indication of the first polarization or OAM mode, the indication of the second polarization or OAM mode, and/or the list of polarizations or OAM modes are transmitted in system information of the first cell.

According to an example embodiment of the fifth aspect, the system information is transmitted on a broadcast channel of the first cell.

According to a sixth aspect, a method may comprise: transmitting, by an access node of a first cell, an indication of a first polarization or orbital angular momentum (OAM) mode configured for single-polarization or single-OAM mode communication at the first cell and an indication of a second polarization or OAM mode configured for single-polarization or single-OAM mode communication at a second cell, wherein the second polarization of OAM mode is substantially orthogonal to the first polarization or OAM mode, and wherein the second cell is adjacent to the first cell; selecting a first antenna configuration for single-polarization or single-OAM mode communication with the first polarization or OAM mode; and transmitting or receiving at least one signal with the first antenna configuration.

According to an example embodiment of the sixth aspect, the indication of the second polarization or OAM mode is included in a list of polarizations or OAM modes associated with at least two of plurality of cells.

According to an example embodiment of the sixth aspect, the plurality of cells are located in a substantially linear pattern, and adjacent cells of the plurality of cells are configured with substantially orthogonal polarizations or OAM modes.

According to an example embodiment of the sixth aspect, the method may further comprise: selecting a second antenna configuration for dual-polarization or multi-OAM mode communication with the first polarization or OAM-mode and the second polarization or OAM mode, wherein the second antenna configuration comprises a second antenna tilt configured to direct the at least one signal to at least one non-edge area of the first cell, and wherein the first antenna configuration comprises a first antenna tilt configured to direct the at least one signal to at least one edge area of the first cell.

According to an example embodiment of the sixth aspect, the method may further comprise: transmitting the at least one signal with the second antenna configuration to the at least one non-edge area of the first cell.

According to an example embodiment of the sixth aspect, the method may further comprise: transmitting a condition for applying a single-polarization or single-OAM mode antenna configuration or a dual-polarization or multi-OAM mode antenna configuration for communication at least at the first cell, wherein the condition comprises a threshold for received signal strength.

According to an example embodiment of the sixth aspect, the method may further comprise: selecting the first antenna configuration, in response to receiving, from at least one core network node, a configuration of the first polarization or OAM mode for single-polarization or single-OAM mode communication at the first cell.

According to an example embodiment of the sixth aspect, the method may further comprise: transmitting the indication of the second polarization or OAM mode configured for single-polarization or single-OAM mode communication at the second cell and/or the list of polarizations or OAM modes, in response to receiving a configuration of the second polarization or OAM mode for single-polarization or single-OAM mode communication at the second cell and/or the list of polarizations or OAM modes from the at least one core network node.

According to an example embodiment of the sixth aspect, the method may further comprise: selecting the first antenna configuration based on a fixed mapping between the first antenna configuration and the first polarization or OAM mode.

According to an example embodiment of the sixth aspect, the indication of the first polarization or OAM mode, the indication of the second polarization or OAM mode, and/or the list of polarizations or OAM modes are transmitted in system information of the first cell.

According to an example embodiment of the sixth aspect, the system information is transmitted on a broadcast channel of the first cell.

According to a seventh aspect a computer program or a computer program product may comprise instructions for causing an apparatus to perform at least the following: transmitting, by an access node of a first cell, an indication of a first polarization or orbital angular momentum (OAM) mode configured for single-polarization or single-OAM mode communication at the first cell and an indication of a second polarization or OAM mode configured for single-polarization or single-OAM mode communication at a second cell, wherein the second polarization of OAM mode is substantially orthogonal to the first polarization or OAM mode, and wherein the second cell is adjacent to the first cell; selecting a first antenna configuration for single-polarization or single-OAM mode communication with the first polarization or OAM mode; and transmitting or receiving at least one signal with the first antenna configuration. The computer program may further comprise instructions for causing the apparatus to perform any example embodiment of the method of the sixth aspect.

According to an eighth aspect an apparatus may comprise: means for transmitting, by an access node of a first cell, an indication of a first polarization or orbital angular momentum (OAM) mode configured for single-polarization or single-OAM mode communication at the first cell and an indication of a second polarization or OAM mode configured for single-polarization or single-OAM mode communication at a second cell, wherein the second polarization of OAM mode is substantially orthogonal to the first polarization or OAM mode, and wherein the second cell is adjacent to the first cell; means for selecting a first antenna configuration for single-polarization or single-OAM mode communication with the first polarization or OAM mode; and means for transmitting or receiving at least one signal with the first antenna configuration. The apparatus may further comprise means for performing any example embodiment of the method of the sixth aspect.

According to a ninth aspect, an apparatus is disclosed. The apparatus may comprise: at least one processor, and at least one memory including computer program code; the at least one memory and the computer program code configured to, with the at least one processor, cause the apparatus at least to: transmit or receive, by an access node of a first cell with at least one antenna, at least one signal to/from at least one edge area of the first cell using single-polarization or single-orbital angular momentum (OAM) mode communication with a first polarization or OAM mode; and transmit or receive, by the access node of the first cell with the at least one antenna, at least one signal to/from at least one non-edge area of the first cell using multi-polarization or multi-OAM mode communication with the first polarization or OAM mode and at least a second polarization or OAM mode, wherein the second polarization or OAM mode is substantially orthogonal to the first polarization or OAM mode and configured for single-polarization or single-OAM mode communication at at least one edge area of a second cell, wherein the second cell is adjacent to the first cell.

According to an example embodiment of the ninth aspect, the apparatus may comprise at least one processor; and at least one memory including computer program code; the at least one memory and the computer program code configured to, with the at least one processor, cause the apparatus at least to: transmit or receive, by an access node of a first cell, at least one signal with a first antenna configuration configured for single-polarization or single-orbital angular momentum (OAM) communication with a first polarization or a first OAM-mode at at least one edge area of the first cell; and transmit or receive, by the access node of the first cell, at least one signal with a second antenna configuration configured for multi-polarization or multi-OAM mode communication with the first polarization or OAM mode and at least a second polarization or OAM mode, wherein the second polarization or OAM mode is substantially orthogonal to the first polarization or OAM mode and configured for single-polarization or single-OAM mode communication at at least one edge area of a second cell, wherein the second cell is adjacent to the first cell, and wherein the second antenna configuration is configured to direct the at least one signal to at least one non-edge area of the first cell.

According to an example embodiment of the ninth aspect, the at least one memory and the computer program code are further configured to, with the at least one processor, cause the apparatus to: transmit, to a device, a condition for applying single-polarization or single-OAM mode communication or multi-polarization or multi-OAM mode communication at least at the first cell, wherein the condition comprises a threshold for a received signal strength.

According to an example embodiment of the ninth aspect, the at least one memory and the computer program code are further configured to, with the at least one processor, cause the apparatus to: receive, from a device, an indication of a received signal strength; and determine to transmit or receive the at least one signal to/from the device using the multi-polarization or multi-OAM mode communication, in response to determining that the received signal strength exceeds a threshold.

According to an example embodiment of the ninth aspect, the at least one memory and the computer program code are further configured to, with the at least one processor, cause the apparatus to: transmit or receive the at least one signal using the single-polarization or single-OAM mode communication or the multi-polarization or multi-OAM mode communication with a beam directed towards the device.

According to an example embodiment of the ninth aspect, the at least one memory and the computer program code are further configured to, with the at least one processor, cause the apparatus to: transmit or receive the at least one signal with the single-polarization or single-OAM mode communication using a first antenna configuration, wherein the first antenna configuration comprises a first antenna tilt configured to direct the at least one signal to the at least one edge area of the first cell; and transmit or receive the at least one signal with the multi-polarization or multi-OAM mode communication using a second antenna configuration, wherein the second antenna configuration comprises a second antenna tilt configured to direct the at least one signal to the at least one non-edge area of the first cell.

According to an example embodiment of the ninth aspect, the received signal strength comprises a carrier-to-interference ratio, a signal-to-interference-plus-noise ratio, or a reference signal received power of the first cell.

According to an example embodiment of the ninth aspect, the first polarization or OAM mode is configured for single-polarization or single-OAM mode communication at at least one edge area of a third cell, wherein the third cell is adjacent to the second cell, and wherein the first cell, the second cell, and the third cell are located in a substantially linear pattern.

According to an example embodiment of the ninth aspect, the first cell may be associated with a first site of a communication network and the second cell may be associated with a second site of the communication network. The first cell may be associated with a first sector of the first site and the second cell may be associated with a second sector of the second site. The first sector may be opposite to the second sector.

According to an example embodiment of the ninth aspect, the communication network may comprise a plurality of sites, wherein edge areas of opposite sectors of adjacent sites are configured with substantially orthogonal polarizations or OAM-modes.

According to an example embodiment of the ninth aspect, the plurality of sites may comprise at least six sectors.

Example embodiment(s) of the ninth aspect may be combined with example embodiment(s) of the fifth aspect.

According to a tenth aspect, a method is disclosed. The method may comprise: transmitting or receiving, by an access node of a first cell with at least one antenna, at least one signal to/from at least one edge area of the first cell using single-polarization or single-orbital angular momentum (OAM) mode communication with a first polarization or OAM mode; and transmitting or receiving, by the access node of the first cell with the at least one antenna, at least one signal to/from at least one non-edge area of the first cell using multi-polarization or multi-OAM mode communication with the first polarization or OAM mode and at least a second polarization or OAM mode, wherein the second polarization or OAM mode is substantially orthogonal to the first polarization or OAM mode and configured for single-polarization or single-OAM mode communication at at least one edge area of a second cell, wherein the second cell is adjacent to the first cell.

According to an example embodiment of the tenth aspect, the method may comprise: transmitting or receiving, by an access node of a first cell, at least one signal with a first antenna configuration configured for single-polarization or single-orbital angular momentum (OAM) communication with a first polarization or a first OAM-mode at at least one edge area of the first cell; and transmitting or receiving, by the access node of the first cell, at least one signal with a second antenna configuration configured for multi-polarization or multi-OAM mode communication with the first polarization or OAM mode and at least a second polarization or OAM mode, wherein the second polarization or OAM mode is substantially orthogonal to the first polarization or OAM mode and configured for single-polarization or single-OAM mode communication at at least one edge area of a second cell, wherein the second cell is adjacent to the first cell, and wherein the second antenna configuration is configured to direct the at least one signal to at least one non-edge area of the first cell.

According to an example embodiment of the tenth aspect, the method may further comprise: transmitting, to a device, a condition for applying single-polarization or single-OAM mode communication or multi-polarization or multi-OAM mode communication at least at the first cell, wherein the condition comprises a threshold for a received signal strength.

According to an example embodiment of the tenth aspect, the method may further comprise: receiving, from a device, an indication of a received signal strength; and determining to transmit or receive the at least one signal to/from the device using the multi-polarization or multi-OAM mode communication, in response to determining that the received signal strength exceeds a threshold.

According to an example embodiment of the tenth aspect, the method may further comprise: transmitting or receiving the at least one signal using the single-polarization or single-OAM mode communication or the multi-polarization or multi-OAM mode communication with a beam directed towards the device.

According to an example embodiment of the tenth aspect, the method may further comprise: transmitting or receiving the at least one signal with the single-polarization or single-OAM mode communication using a first antenna configuration, wherein the first antenna configuration comprises a first antenna tilt configured to direct the at least one signal to the at least one edge area of the first cell; and transmitting or receiving the at least one signal with the multi-polarization or multi-OAM mode communication using a second antenna configuration, wherein the second antenna configuration comprises a second antenna tilt configured to direct the at least one signal to the at least one non-edge area of the first cell.

According to an example embodiment of the tenth aspect, the received signal strength comprises a carrier-to-interference ratio, a signal-to-interference-plus-noise ratio, or a reference signal received power of the first cell.

According to an example embodiment of the tenth aspect, the first polarization or OAM mode is configured for single-polarization or single-OAM mode communication at at least one edge area of a third cell, wherein the third cell is adjacent to the second cell, and wherein the first cell, the second cell, and the third cell are located in a substantially linear pattern.

According to an example embodiment of the tenth aspect, the first cell may be associated with a first site of a communication network and the second cell may be associated with a second site of the communication network. The first cell may be associated with a first sector of the first site and the second cell may be associated with a second sector of the second site. The first sector may be opposite to the second sector.

According to an example embodiment of the tenth aspect, the communication network may comprise a plurality of sites, wherein edge areas of opposite sectors of adjacent sites are configured with substantially orthogonal polarizations or OAM-modes.

According to an example embodiment of the tenth aspect, the plurality of sites may comprise at least six sectors

Example embodiment(s) of the tenth aspect may be combined with example embodiment(s) of the sixth aspect.

According to an eleventh aspect, a computer program or a computer program product is disclosed. The computer program or a computer program product may comprise instructions for causing an apparatus to perform any example embodiment of the method of the tenth aspect.

According to a twelfth aspect, an apparatus is disclosed. The apparatus may comprise means for causing an apparatus to perform any example embodiment of the method of the tenth aspect.

According to a thirteenth aspect, an apparatus is disclosed. The apparatus may comprise: at least one processor; and at least one memory including computer program code; the at least one memory and the computer program code configured to, with the at least one processor, cause the apparatus at least to: determine to transmit or receive at least one signal using single-polarization or single-OAM communication with a first polarization or OAM mode at a first cell, in response to determining that a received signal strength of the first cell does not exceed a threshold, or in response to receiving, from an access node of the first cell, a request for single-polarization or single-OAM communication at the first cell; determine to transmit or receive at least one signal using multi-polarization or multi-OAM communication with the first polarization or OAM mode and at least a second polarization or OAM mode at the first cell, in response to determining that the received signal strength of the first cell exceeds the threshold, or in response to receiving, from the access node of the first cell, a request for multi-polarization or multi-OAM communication at the first cell, wherein the second polarization or OAM mode is substantially orthogonal to the first polarization or OAM mode; and transmit or receive the at least one signal to/from the first cell using the single-polarization or single-OAM communication or the multi-polarization or multi-OAM communication, or transmit an indication of the single-polarization or single-OAM communication or the multi-polarization or multi-OAM communication to an external antenna device for transmission or reception of the at least one signal to/from the first cell via the external antenna device.

According to an example embodiment of the thirteenth aspect, the apparatus may comprise at least one processor; and at least one memory including computer program code; the at least one memory and the computer program code configured to, with the at least one processor, cause the apparatus at least to: select a first antenna configuration for single-polarization or single-OAM communication with a first polarization or OAM mode at a first cell, in response to determining that a received signal strength of the first cell does not exceed a threshold, or in response to receiving, from an access node of the first cell, a request for single-polarization or single-OAM communication at the first cell; select a second antenna configuration for multi-polarization or multi-OAM communication with the first polarization or OAM mode and at least a second polarization or OAM mode at the first cell, in response to determining that the received signal strength of the first cell exceeds the threshold, or in response to receiving, from the access node of the first cell, a request for multi-polarization or multi-OAM communication at the first cell, wherein the second polarization or OAM mode is substantially orthogonal to the first polarization or OAM; and transmit or receive at least one signal to/from the first cell with the selected first or second antenna configuration, or transmit an indication of the selected first or second antenna configuration to an external antenna device for transmission or reception of the at least one signal to/from the first cell via the external antenna device.

According to an example embodiment of the thirteenth aspect, the second polarization or OAM mode is configured for single-polarization or single-OAM mode communication at at least one edge area of a second cell, wherein the second cell is adjacent to the first cell.

According to an example embodiment of the thirteenth aspect, the threshold for the received signal strength is pre-configured at the apparatus.

According to an example embodiment of the thirteenth aspect, the at least one memory and the computer program code are further configured to, with the at least one processor, cause the apparatus to: receive, from the access node of the first cell, a condition for using the single-polarization or single-OAM mode communication or the multi-polarization or multi-OAM communication at least at the first cell, wherein the condition comprises the threshold for the received signal strength.

According to an example embodiment of the thirteenth aspect, the at least one memory and the computer program code are further configured to, with the at least one processor, cause the apparatus to: measure the received signal strength of the first cell; and transmit an indication of the received signal strength of the first cell to the access node.

According to an example embodiment of the thirteenth aspect, the at least one memory and the computer program code are further configured to, with the at least one processor, cause the apparatus to: select a first antenna configuration for the single-polarization or single-OAM communication with the first polarization or OAM mode based on received signal strength measurements of a plurality of antenna configurations configured for different polarizations or OAM modes.

According to an example embodiment of the thirteenth aspect, the at least one memory and the computer program code are further configured to, with the at least one processor, cause the apparatus to: switch to single-polarization or single-OAM mode communication with the second polarization or OAM mode and transmit or receive at least one signal to/from the second cell with the second polarization or OAM mode, or transmit an indication of the second polarization or OAM mode to the external antenna device and transmit or receive the at least one signal to/from the second cell via the external antenna device.

According to an example embodiment of the thirteenth aspect, the at least one memory and the computer program code are further configured to, with the at least one processor, cause the apparatus to: switch to single-polarization or single-OAM mode communication with the second polarization or OAM mode, or transmit the indication of the second polarization or OAM mode to the external antenna device, in response to performing a cell re-selection or a handover to the second cell.

According to an example embodiment of the thirteenth aspect, the at least one memory and the computer program code are further configured to, with the at least one processor, cause the apparatus to: enable communication with the second polarization or OAM mode, in response to detecting the received signal strength from the first cell to decrease below or equal to a second threshold; continue transmission or reception of the at least one signal to/from the first cell with the first polarization or OAM mode, or transmit an indication of the first and second polarizations or OAM modes to the external antenna device to continue transmission or reception of the at least one signal to/from the first cell via the external antenna device; perform neighbour cell measurements with the second polarization or OAM mode; and perform the cell re-selection or the handover to the second cell based on the neighbour cell measurements.

According to an example embodiment of the thirteenth aspect, the threshold is higher than the second threshold.

According to an example embodiment of the thirteenth aspect, the at least one memory and the computer program code are further configured to, with the at least one processor, cause the apparatus to: measure received signal strength from the first cell with a first antenna configuration; measure received signal strength from the first cell with a second antenna configuration; and select the first antenna configuration for single-polarization or single-OAM mode communication at the first cell, in response to determining that the received signal strength measured with the first antenna configuration exceeds the received signal strength measured with the third antenna configuration.

Example embodiment(s) of the thirteenth aspect may be combined with example embodiment(s) of the first aspect.

According to a fourteenth aspect, a method is disclosed. The method may comprise: determining to transmit or receive at least one signal using single-polarization or single-OAM communication with a first polarization or OAM mode at a first cell, in response to determining that a received signal strength of the first cell docs not exceed a threshold, or in response to receiving, from an access node of the first cell, a request for single-polarization or single-OAM communication at the first cell; determining to transmit or receive at least one signal using multi-polarization or multi-OAM communication with the first polarization or OAM mode and at least a second polarization or OAM mode at the first cell, in response to determining that the received signal strength of the first cell exceeds the threshold, or in response to receiving, from the access node of the first cell, a request for multi-polarization or multi-OAM communication at the first cell, wherein the second polarization or OAM mode is substantially orthogonal to the first polarization or OAM mode; and transmitting or receiving the at least one signal to/from the first cell using the single-polarization or single-OAM communication or the multi-polarization or multi-OAM communication, or transmitting an indication of the single-polarization or single-OAM communication or the multi-polarization or multi-OAM communication to an external antenna device for transmission or reception of the at least one signal to/from the first cell via the external antenna device.

According to an example embodiment of the fourteenth aspect, the method may comprise: selecting a first antenna configuration for single-polarization or single-OAM communication with a first polarization or OAM mode at a first cell, in response to determining that a received signal strength of the first cell does not exceed a threshold, or in response to receiving, from an access node of the first cell, a request for single-polarization or single-OAM communication at the first cell; selecting a second antenna configuration for multi-polarization or multi-OAM communication with the first polarization or OAM mode and at least a second polarization or OAM mode at the first cell, in response to determining that the received signal strength of the first cell exceeds the threshold, or in response to receiving, from the access node of the first cell, a request for multi-polarization or multi-OAM communication at the first cell, wherein the second polarization or OAM mode is substantially orthogonal to the first polarization or OAM; and transmitting or receiving at least one signal to/from the first cell with the selected first or second antenna configuration, or transmitting an indication of the selected first or second antenna configuration to an external antenna device for transmission or reception of the at least one signal to/from the first cell via the external antenna device.

According to an example embodiment of the fourteenth aspect, the second polarization or OAM mode is configured for single-polarization or single-OAM mode communication at at least one edge area of a second cell, wherein the second cell is adjacent to the first cell.

According to an example embodiment of the fourteenth aspect, the threshold for the received signal strength is pre-configured at the apparatus.

According to an example embodiment of the fourteenth aspect, the method may comprise: receiving, from the access node of the first cell, a condition for using the single-polarization or single-OAM mode communication or the multi-polarization or multi-OAM communication at least at the first cell, wherein the condition comprises the threshold for the received signal strength.

According to an example embodiment of the fourteenth aspect, the method may comprise: measuring the received signal strength of the first cell; and transmitting an indication of the received signal strength of the first cell to the access node.

According to an example embodiment of the fourteenth aspect, the method may comprise: selecting a first antenna configuration for the single-polarization or single-OAM communication with the first polarization or OAM mode based on received signal strength measurements of a plurality of antenna configurations configured for different polarizations or OAM modes.

According to an example embodiment of the fourteenth aspect, the method may comprise: switching to single-polarization or single-OAM mode communication with the second polarization or OAM mode, or transmit an indication of the second polarization or OAM mode to the external antenna device, in response to performing a cell re-selection or a handover to the second cell.

According to an example embodiment of the fourteenth aspect, the method may comprise: enabling communication with the second polarization or OAM mode, in response to detecting the received signal strength from the first cell to decrease below or equal to a second threshold; continuing transmission or reception of the at least one signal to/from the first cell with the first polarization or OAM mode, or transmitting an indication of the first and second polarizations or OAM modes to the external antenna device to continue transmission or reception of the at least one signal to/from the first cell via the external antenna device; performing neighbour cell measurements with the second polarization or OAM mode; and performing the cell re-selection or the handover to the second cell based on the neighbour cell measurements.

According to an example embodiment of the fourteenth aspect, the threshold is higher than the second threshold.

According to an example embodiment of the fourteenth aspect, the method may comprise: measuring received signal strength from the first cell with a first antenna configuration; measuring received signal strength from the first cell with a second antenna configuration; and selecting the first antenna configuration for the single-polarization or single-OAM mode communication at the first cell, in response to determining that the received signal strength measured with the first antenna configuration exceeds the received signal strength measured with the third antenna configuration.

Example embodiment(s) of the fourteenth aspect may be combined with example embodiment(s) of the second aspect.

According to an fifteenth aspect, a computer program or a computer program product is disclosed. The computer program or a computer program product may comprise instructions for causing an apparatus to perform any example embodiment of the method of the fourteenth aspect.

According to a sixteenth aspect, an apparatus is disclosed. The apparatus may comprise means for causing an apparatus to perform any example embodiment of the method of the fourteenth aspect.

Any of the above example embodiments may be combined with one or more other example embodiments. Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to understand the example embodiments. In the drawings:

FIG. 1 illustrates an example of a communication network;

FIG. 2 illustrates an example of an apparatus configured to practice one or more example embodiments;

FIG. 3 illustrates an example of a communication network configured with same polarization at adjacent cells;

FIG. 4 illustrates an example of a communication network configured with orthogonal polarizations at adjacent cells;

FIG. 5 illustrates an example of interference between dual-polarized cells;

FIG. 6 illustrates an example of a communication network with a substantially linear pattern of cells configured with orthogonal polarizations at adjacent cells;

FIG. 7 illustrates an example of signalling and operations for configuring polarization of cells at a communication network;

FIG. 8 illustrates an example of a trajectory of a user equipment from a first cell to a second cell;

FIG. 9 illustrates an example of a method for selecting antenna configuration based on polarization or OAM mode;

FIG. 10 illustrates an example of a method for selecting antenna configuration based on measurements;

FIG. 11 illustrates an example of signalling and operations for configuring polarization of cells at a communication network, when user equipment communicates via an external antenna device;

FIG. 12 illustrates an example of a method for selecting antenna configuration, polarization, or OAM mode;

FIG. 13 illustrates an example of a method for configuring polarization or OAM mode of a cell;

FIG. 14 illustrates an example of a site with six sectors;

FIG. 15 illustrates an example of a hexagonal six-sectored network topology;

FIG. 16 illustrates an example of communication with a device located at an edge area or a non-edge areas of a cell; and

FIG. 17 illustrates an example of a method for communication at an edge area or a non-edge area of a cell.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Polarization of electromagnetic radio signals may be exploited in wireless communication networks, for example to generate multiple orthogonal transmission channels for MIMO (multiple input-multiple output) communications. Type of linear polarization may be for example defined by the plane in which the electric field of the radio signal vibrates. Examples of linear polarizations include horizontal (H), vertical (V), and slanted (e.g. ±45°) polarizations. It is generally beneficial to match the polarization of the receive antenna to the polarization of the received signal, in order to avoid degradation in signal strength due to mismatch of polarization. In line-of-sight (LOS) propagation conditions radio signals generally maintain their polarization, since the polarization is not significantly diverged by reflections or diffractions in the radio channel.

Ideally, signals having 90° offset in polarization with respect to the receive antenna do not affect the electromagnetic state of the receive antenna. Polarizations with exactly 900 degree offset (e.g. horizontal and vertical or +45° and −45°) are therefore orthogonal with each other. However, due to various implementation aspects, such as for example tolerances in antenna installation, the offset between polarizations of the transmit and receive antennas may not be exactly 90°. Furthermore, reflections or diffractions in the radio channel may cause polarization of the radio signal to diverge such that the signal is observable also with an orthogonally polarized receive antenna. In many cases it is however sufficient to have substantially orthogonal polarizations, for example such that leakage between the “orthogonal” polarizations is tolerable for practical applications. Even though some example embodiments have been described using linear polarizations (e.g. horizontal and vertical) as examples, orthogonal polarizations may be obtained also using circular or elliptical polarizations.

Another way for creating orthogonal transmission channels is to exploit the orbital angular momentum (OAM), which is an intrinsic property of electromagnetic waves. Signals transmitted with different OAM modes are orthogonal with each other and therefore ideally free of mutual interference. Signals transmitted with OAM, having a wavefront with helical phase, may be also called radio vortex signals. Similar to polarization, transmit and receive antennas may be configured to support particular OAM-mode(s). Antenna configurations configured for transmission and/or reception of one OAM mode may be called single-OAM antenna configurations. Antenna configurations configured for (simultaneous) transmission and/or reception of multiple OAM modes may be called multi-OAM antenna configurations.

Radio vortex signals may be transmitted and/or received for example by spiral phase plate (SPP) antennas or uniform circular array (UCA) antennas. In case of an SPP antenna, a receiver may multiply the received OAM-signal with a conjugate phase related to the OAM-mode of the received signal, in order to transform the OAM-wave into a plane wave. In case of a UCA antenna, a spatial fast Fourier transform (FFT) may be used to obtain the signal carried by the particular OAM-mode. OAM may be therefore used as another property for generating orthogonal signals, in addition to different linear polarizations. It is noted that even though some example embodiments have been described using polarization as an example, similar example embodiments may be applied also for OAM. However, instead of the two orthogonal polarizations available for linearly polarized signals, multiple OAM modes may be used for creating multiple orthogonal transmission channels. It is further noted that an antenna configuration may comprise a physical antenna configuration or an algorithmic antenna configuration (e.g. a certain conjugate phase), for example to receive signal(s) with particular OAM mode(s).

As capacity requirements for cellular connectivity get more demanding, it is a tendency to decrease the cell size in order to improve the overall capacity of the network. This increases the probability for experiencing LOS conditions within the network. On the other hand, in rural areas signals experience less reflections and therefore LOS conditions may be prevailing also at larger cells. In many applications, cells of the network may be arranged in a linear pattern, e.g. one cell following another. Such network structure may be selected for example when providing radio coverage for motorways, but the situation may be also effectively the same in urban environments due to the street canyon effect, which may limit radio propagation to an elongated coverage area. This may be the case for example when transmit antennas of access nodes are located below the roof top level, e.g. in case of lamp post implementations, or at indoor environments. Generally, radio connections at higher frequencies, for example above 100 GHz or in the THz range, are more likely to be realized with LOS conditions due to the higher propagation loss associated with the higher frequency. It is however noticed that example embodiments may be applied also in non-LOS conditions.

Neighbouring cells may cause interference to each other and this may cause the achievable capacity to decrease, especially at edge areas of the neighbouring cells. Example embodiments of the present disclosure improve the overall capacity of cellular communication networks by coordinating polarizations or OAM-modes in adjacent cells such that interference between adjacent cells is reduced.

According to an example embodiment, an apparatus may receive, from an access node of a first cell, an indication of a first polarization or OAM mode configured for single-polarization or single-OAM communication at the first cell and an indication of a second (orthogonal or substantially orthogonal) polarization or OAM mode configured for single-polarization or single-OAM communication at a second cell, wherein the second cell is adjacent to the first cell; and select a first antenna configuration for single-polarization or single-OAM communication with the first polarization or OAM mode and transmit or receive at least one signal to/from the first cell with the first antenna configuration, or transmit an indication of the first polarization or OAM mode or the first antenna configuration to an external antenna device and transmit or receive the at least one signal to/from the first cell via the external antenna device. This enables coordination of polarization or OAM mode between cells, and optionally also within cells, such that overall transmission capacity is improved.

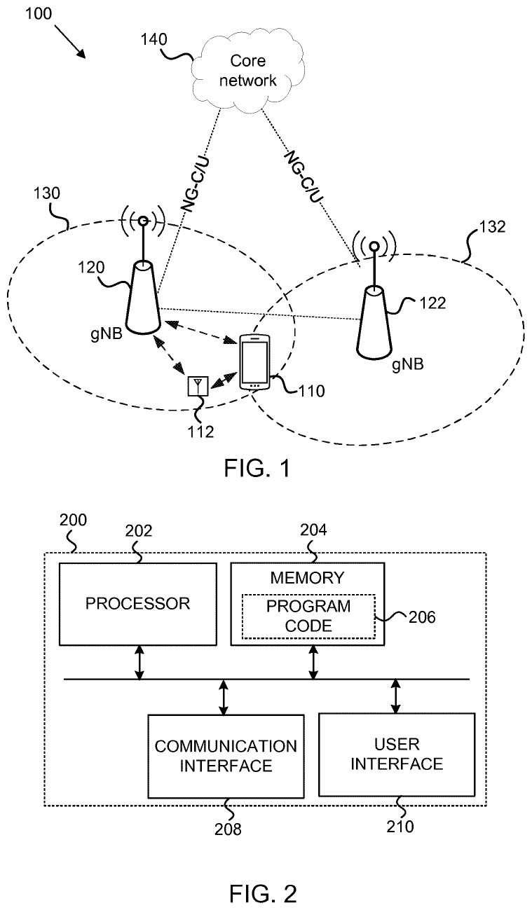

FIG. 1 illustrates an example of a communication network. Communication network 100 may comprise one or more devices, which may be also referred to as client nodes, user nodes, or user equipment (UE). An example of a device is UE 110, which may communicate with one or more access nodes or access points, represented in this example by a 5^{th} generation access nodes (gNB), over wireless radio channel(s). Communications between UE 110 and gNBs 120, 122 may be bidirectional and hence any of these entities may be configured to operate as a transmitter, and/or a receiver.

Communication network 100 may be a terrestrial network. It is however possible to apply the example embodiments with other type of networks, such as for example a non-terrestrial network.

An access node may be associated with a cell, which may correspond to a geographical area covered by signals transmitted by the access node. For example, gNB 120 may provide communication services to UE 110 within cell 130. It is however possible that multiple access nodes (e.g. repeaters) are arranged within one cell. The gNB 120 may be equipped an omnidirectional antenna(s), thereby providing a circular coverage area, as illustrated in FIG. 1. It is however possible to apply directive antennas to cover a desired area. It is further possible to apply beamforming such that different UEs are served by different beams of the cell. For example, gNB 120 may serve UE 110 with one beam and another UE with another beam. A cell may be identified by a cell identifier (ID), for example a physical cell ID (PCI). In general, a cell may comprise a coverage area of signals associated with a particular cell identifier. Within the coverage area of a cell (e.g. cell 130), UE 110 may be enabled to access the network via an access point (e.g. gNB 120) of the cell.

UE 110 may communicate data with gNB 120 directly. UE 110 may for example transmit signal to gNB 120 or receive signals from gNB 120. Alternatively, UE 110 may communicate with gNB 120 via an external antenna device 112. Transmissions from a device to an access node, e.g. from UE 110 or external antenna device 112 to gNB 120, may be referred to as uplink transmissions. Transmissions from an access node to a device may be referred to as downlink transmissions. External antenna device 112 may be any suitable device enabling UE 110 to communicate data with gNB 120, e.g. transmit and/or receive signals to/from gNB120, such as for example an earbud, a “car kit” for a vehicle such as for example a car, a bus, or a train, a fixed wireless access (FWA) point, a smart ring, or the like. It is noted that some external antenna devices may be deployed with a fixed orientation such that antenna(s) of the external antenna device 112 are located in a fixed orientation with respect to respective antenna(s) of gNB 120. Therefore, different antennas or antenna configurations of external antenna device 112 may have a fixed mapping to different polarizations or OAM-modes. Alternatively, orientation of external antenna device 112, or the antenna(s) thereof, may change.

External antenna device 112 may be communicatively coupled to UE 110 by any suitable means, for example with a wireless radio connection. External antenna device 112 may for example act as a wireless repeater for cellular signals (e.g. 5G, 6G). Alternatively, external antenna device 112 may decode the received signal and communicate with UE 110 in some other format, e.g. Wi-Fi, Bluetooth, or the like. In such case, external antenna device 112 may itself operate as a UE. The external antenna device 112 may be also coupled to UE 110 with any suitable wired connection.

Communication network 100 may further comprise a core network 140 one or more core network elements (not shown), for example network nodes, network devices, or network functions. Core network 140 may for example comprise an access and mobility management function (AMF) and/or user plane function (UPF), which enable gNBs 120, 122 to provide various communication services for UE 110. The gNB 120 may be configured to communicate with the core network elements over a communication interface, such as for example a control plane interface and/or a user plane interface (e.g. NG-C/U). Access nodes, such as gNBs 120, 122, may be also called base stations or a radio access network (RAN) nodes and they may be part of a RAN between core network 140 and UE 110. Functionality of an access node may be distributed between a central unit (CU), for example a gNB-CU, and one or more distributed units (DU), for example gNB-DUs. It is therefore appreciated that access node functionality described herein may be implemented at a gNB, or divided between a gNB-CU and a gNB. Network elements such as gNB, gNB-CU, and gNB-DU may be generally referred to as network nodes or network devices. Although depicted as a single device, a network node may not be a stand-alone device, but for example a distributed computing system coupled to a remote radio head.

Communication network 100 may be configured for example in accordance with the 5th generation (5G) digital cellular communication network, as defined by the 3rd Generation Partnership Project (3GPP). In one example, the communication network 100 may operate according to 3GPP 5G NR (New Radio). It is however appreciated that example embodiments presented herein are not limited to this example network and may be applied in any present or future wireless or wired communication networks, or combinations thereof, for example other type of cellular networks, short-range wireless networks, broadcast or multicast networks, or the like.

Data communication in communication network 100 may be based on a protocol stack comprising various communication protocols and layers. Layers of the protocol stack may be configured to provide certain functionalities, for example based on the Open Systems Interconnection (OSI) model or a layer model of a particular standard, such as for example 5G NR. The physical layer (Layer 1) may provide data transmission services on physical layer channels such as for example the physical broadcast channel (PBCH), physical downlink control channel (PDCCH), physical downlink shared channel (PDSCH), physical uplink control channel (PUCCH), physical uplink shared channel (PUSCH), or physical random access channel (PRACH). The physical layer may for example perform modulation, forward error correction (FEC) coding, define a physical layer frame structure, etc., to transmit upper layer data (e.g. transport channels) at the physical channels.

System information may comprise signalling information provided by gNB 120 to UE 110. System information enables UE 110 to carry out various tasks, such as for example to establish a connection to the access points and/or core network 140. System information may be provided by any suitable means, for example as one or more master information blocks (MIB) and/or system information blocks (SIB). System information may be provided at least partially on PBCH. Alternatively, or additionally, system information may be provided on PDCCH. For example, when UE 110 is powered on, it may start searching for synchronization signals (e.g. primary/secondary synchronization signals, PSS/SSS) and decode PBCH. PBCH, or in general the system information, may comprise information about polarization or OAM configurations for different cells, as will be further described below.

UE 110 may be in different radio resource control modes or states with respect to gNB 120. When UE 110 is powered up, it may be in a disconnected mode or an idle mode (e.g. RCC_IDLE). UE 110 may move to a connected mode (e.g. RRC_CONNECTED) mode for example through connection establishment to the network. If UE 110 is not active for a certain time, UE 110 may move from the connected mode to an inactive mode (e.g. RCC_INACTIVE).

In the idle mode, the UE 110 may not be associated with an RRC (radio resource control) context. From the network point of view there may not be a connection between the radio access network and core network 140 for UE 110. Therefore, UE 110 may not communicate application data with core network 140. UE 110 may be also in a sleep-mode and only intermittently wake-up to receive data, for example paging messages and/or at least part of the system information. UE 110 may however perform cell re-selection to switch from one cell to another in the idle mode.

In the inactive state, UE 110 may stay registered to the network and the connection to the radio access network may be suspended. The radio access network may store the UE context, which enables the connection to be quickly resumed. However, the connection to core network 140 may be maintained. UE 110 may move to the inactive mode from the connected mode. UE 110 may move to the idle mode from the connected or inactive mode.

In the connected mode, UE 110 may be associated with an RRC context and UE 110 may communicate with core network 140 via the radio access network, for example gNB 120. Furthermore, UE 110 may perform radio resource management (RRM) measurements, for example in relation to a mobility (handover) procedure. UE 110 may perform a handover to switch from one cell to another in the connected mode. UE 110 may report its handover measurement results to the network, for example periodically and/or in response to detecting a reporting triggering criterion to be fulfilled.

FIG. 2 illustrates an example embodiment of an apparatus 200, for example UE 110, gNB 120, 122, external antenna device 112, or a component or a chipset of UE 110, gNB 120, 122, or external antenna device 112, configure to practice one or more example embodiments. Apparatus 200 may comprise at least one processor 202. The at least one processor 202 may comprise, for example, one or more of various processing devices or processor circuitry, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

Apparatus 200 may further comprise at least one memory 204. The at least one memory 204 may be configured to store, for example, computer program code or the like, for example operating system software and application software. The at least one memory 204 may comprise one or more volatile memory devices, one or more non-volatile memory devices, and/or a combination thereof. For example, the at least one memory 204 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

Apparatus 200 may further comprise a communication interface 208 configured to enable apparatus 200 to transmit and/or receive information to/from other devices. In one example, apparatus 200 may use communication interface 208 to transmit or receive signaling information and/or data in accordance with at least one cellular communication protocol. Communication interface 208 may be configured to provide at least one wireless radio connection, such as for example a 3GPP mobile broadband connection (e.g. 3G, 4G, 5G, 6G). However, the communication interface may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection such as for example a local area network (LAN) connection, a universal serial bus (USB) connection or an optical network connection, or the like; or a wired Internet connection. Communication interface 208 may comprise, or be configured to be coupled to, an antenna or a plurality of antennas to transmit and/or receive radio frequency signals. One or more of the various types of connections may be also implemented as separate communication interfaces, which may be coupled or configured to be coupled to an antenna or a plurality of antennas.

Apparatus 200 may further comprise a user interface 210 comprising an input device and/or an output device. The input device may take various forms such a keyboard, a touch screen, or one or more embedded control buttons. The output device may for example comprise a display, a speaker, a vibration motor, or the like.

When apparatus 200 is configured to implement some functionality, some component and/or components of apparatus 200, such as for example the at least one processor 202 and/or the at least one memory 204, may be configured to implement this functionality. Furthermore, when the at least one processor 202 is configured to implement some functionality, this functionality may be implemented using program code 206 comprised, for example, in the at least one memory 204.

The functionality described herein may be performed, at least in part, by one or more computer program product components such as for example software components. According to an embodiment, the apparatus comprises a processor or processor circuitry, such as for example a microcontroller, configured by the program code when executed to execute the embodiments of the operations and functionality described. A computer program or a computer program product may therefore comprise instructions for causing, when executed, apparatus 200 to perform the method(s) described herein. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), Graphics Processing Units (GPUs).

Apparatus 200 comprises means for performing at least one method described herein. In one example, the means comprises the at least one processor 202, the at least one memory 204 including program code 206 configured to, when executed by the at least one processor, cause the apparatus 200 to perform the method. Apparatus 200 may for example comprise means for generating, transmitting, and/or receiving wireless communication signals, for example modulation circuitry, demodulation circuitry, radio frequency (RF) circuitry, or the like. The circuitry(ies) may be coupled to, or configured to be coupled to, one or more antennas to transmit and/or receive the wireless communication signals over an air interface.

Apparatus 200 may comprise a computing device such as for example an access point, a base station, user equipment, a mobile phone, a smartphone, a tablet computer, a laptop, an internet of things (IoT) device, or the like. Examples of IoT devices include, but are not limited to, consumer electronics, wearables, sensors, and smart home appliances. In one example, apparatus 200 may comprise a vehicle such as for example a car. Although apparatus 200 is illustrated as a single device it is appreciated that, wherever applicable, functions of apparatus 200 may be distributed to a plurality of devices, for example to implement example embodiments as a cloud computing service.

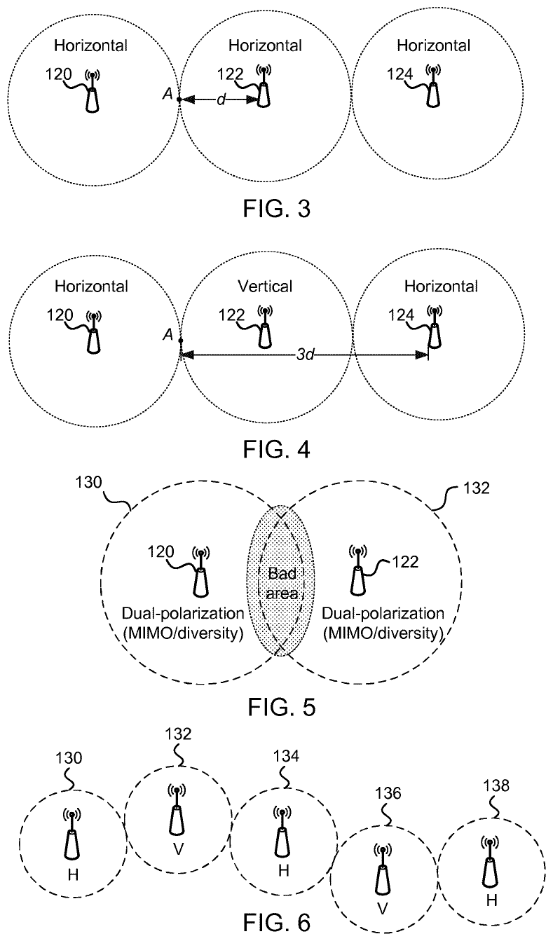

FIG. 3 illustrates an example of a communication network configured with same polarization at adjacent cells. In this example, gNB 120 is associated with a first cell, which is a neighbouring cell of a second cell served by gNB 122. A third cell, served by gNB 124, is a neighbouring cell to the second cell. The gNBs 120, 122, 124 are arranged in a linear pattern such that gNB 122 is located at a line between gNBs 120, 124. In this example, omnidirectional radiation pattern is assumed for gNBs 120, 122, 124 and distances from gNBs 120, 124 to gNB 122 are identical. Horizontal polarization may be configured for transmitting signals by gNBs 120, 122, 124 at the respective cells. If UE 110 is located at point “A”, being served by gNB 120, the distance to the closest neighbouring gNB having the same polarization is “d”. UE 110 therefore experiences strong interference from the neighbouring cell (gNB 122).

FIG. 4 illustrates an example of a communication network configured with orthogonal polarizations at adjacent cells. In this example, gNBs 120, 122, 124 are provided at same locations as in FIG. 3, but gNB 122 is configured with vertical polarization, which is orthogonal to the horizontal polarization of the two neighbouring cells served by gNBs 120, 124. It is however noted that any suitable mutually orthogonal polarizations may be used instead of horizontal and vertical polarizations. It is observed that the distance from UE 110 located at point “A” to the closest neighbouring gNB having the same polarization (horizontal) is now “3d”. UE 110 therefore experiences significantly less interference from the neighbouring cells, because ideally no interference is received from gNB 122 and gNB 124 is located further away from gNB 122.

FIG. 5 illustrates an example of interference between dual-polarized cells. The gNBs 120, 122, as well as UE 110, may be equipped with antennas for both horizontal and vertical polarizations, or in general for any two orthogonal polarizations. The two orthogonal polarizations may be exploited for MIMO coding of data to two respective orthogonal transmission channels in order to increase capacity. Alternatively, the two polarizations may be used for improving transmission robustness by TX/RX diversity (e.g. transmitting/receiving same signal with both polarizations and combining the signals at the receiver).

In mobile communication networks, the capacity/throughput obtainable at the edge of two neighbouring cells may be generally worse than close to one of the respective access points. Either the received signal is weak (e.g. in rural areas) or the access points interfere one another (e.g. in small cell environment) because it may be generally desired to use same frequencies at both access points. UE 110 and/or gNB 120, 122 may measure the state of the radio channels and determine based on the measurements whether to use the different polarizations for capacity increase by MIMO, or alternatively for diversity. The network may be however configured to use same polarization configuration (H+V) at both cells. While this may be preferred in some network configurations, the performance of the network may be further improved, for example in case of LOS conditions. It has been observed that using the same polarization(s) may cause a bad reception area to appear close to the cell edges between two access points. This area may for example correspond to 20-30% of the distance between the access nodes. As the cell size decreases, the bad reception area may in the worst case cover the entire cell. The bad reception area may therefore sometimes comprise 100% of the distance between the access nodes. This may happen for example in case of lamp post implementations, where the distance between the gNBs may be for example 50 m.

If polarization of the cells is coordinated such that adjacent cells use mutually orthogonal polarizations, the interference is reduced significantly, for example in case of small cell or lamp post type of implementations where LOS conditions occur frequently. In LOS conditions, the direct propagation (LOS) component is dominant and reflected or diffracted components are weak enough not to cause any significant distortion. A LOS component received from the neighbouring cell with a substantially orthogonal polarization does not cause significant interference, which greatly reduces the interference level (cf. FIG. 3 and FIG. 4). Thanks to the reduced interference level, the capacity/throughput for a single transmission channel may be larger than the capacity of two orthogonal transmission channels in presence of strong interference from the neighbouring cell. Therefore, while application of single polarization prevents using the two orthogonal transmission channels for capacity increase, the reduction of interference may surprisingly still enable higher capacity with a single transmission channel. LOS conditions area also suitable for communication with orthogonal OAM modes.

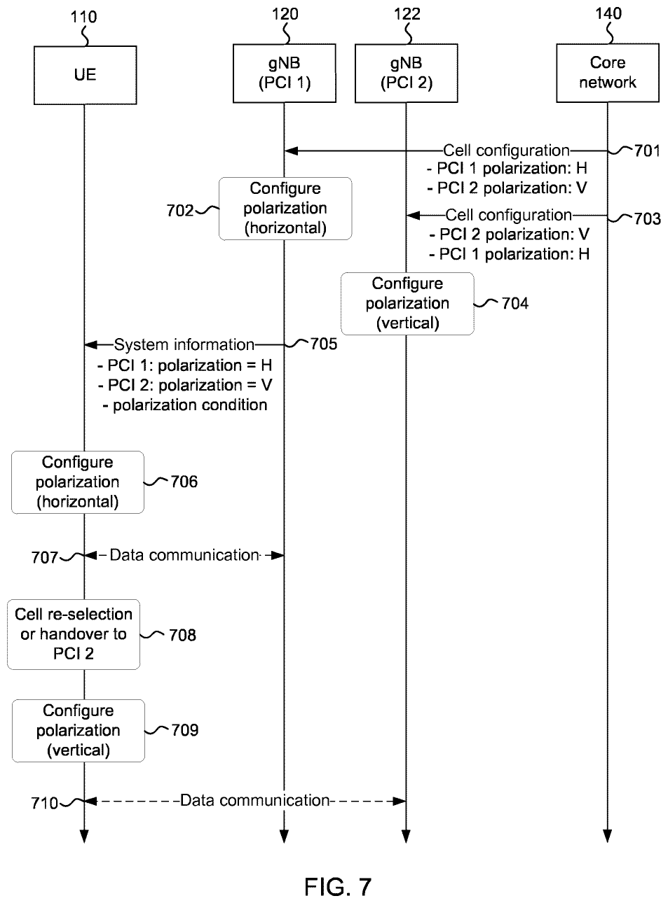

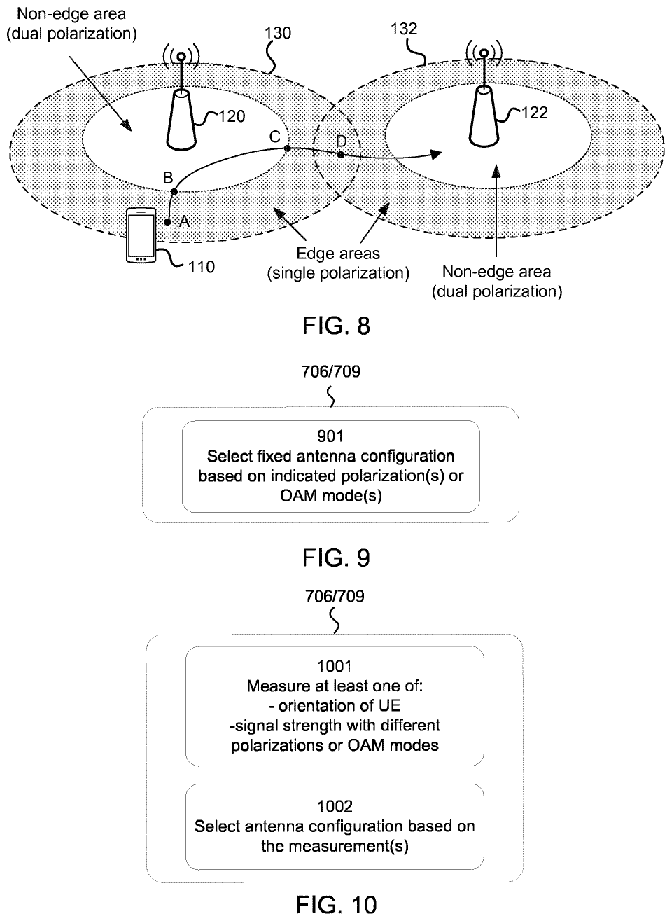

FIG. 6 illustrates an example of a communication network with a substantially linear pattern of cells configured with orthogonal polarizations at adjacent cells. The substantially linear cell pattern of FIG. 6 may be for example used to provide radio coverage for a motorway, or other elongated coverage area. Cells 130, 134, 138 may be configured with one polarization (e.g. H) and cells 132, 136 may be configured with a polarization (e.g. V) orthogonal to polarization of cells 130, 134, 138. Alternatively, adjacent cells may be configured with substantially orthogonal OAM modes. Cells of the network may be therefore located in a substantially linear pattern and adjacent cells may be configured with substantially orthogonal polarizations or OAM modes. Contrary to FIG. 3 and FIG. 4 the gNBs of these cells may not be located exactly on the same line. It is however appreciated that interference between cells configured with the same polarization reduces similar to FIG. 4, even if to a slightly lower extent. In a substantially linear arrangement of cells, coverage areas of at most two cells may overlap with each other. It is however noted that configuration of orthogonal polarization for at least one adjacent cell reduces interference even if there were other adjacent cells configured with the same polarization. In case of OAM modes, different OAM modes may be configured for more than two adjacent cells. For example, three cells being adjacent to each other may be configured with three different OAM modes, respectively. The example embodiments of the present disclosure may be therefore applied also for other types of network layouts, such as for example hexagonal shaped cells in a honeycomb like network structure. It is further noted that the network may be configured with more that two alternative polarizations or OAM modes. For example, a first cell (e.g. cell 130) could be configured with horizontal polarization. A second cell (e.g. cell 134) could be configured with slanted +45° polarization. A third cell (e.g. cell 132) could be configured with vertical polarization. A fourth cell (e.g. cell 136) could be configured with slanted −45° polarization. A fifth cell (e.g. cell 138) could be configured with right-hand sided circular polarization (RHCP). A sixth cell (e.g. adjacent to cell 138) could be configured with left-hand sided circular polarization (LHCP). Alternatively, if two polarizations are configured for a single cell (e.g. for transmissions to a non-edge area of the cell, cf. FIG. 8) the first cell could be configured with horizontal polarization and RHCP. the second cell could be configured with slanted +45° and vertical polarizations. The third cell could be configured with slanted −45° polarization and LHCP. Any suitable combination of polarizations may be used. As noted above, some adjacent cells of a particular cell may have orthogonal polarization with respect to the particular cell, but some adjacent cells may have a non-orthogonal polarization with respect to the particular cell. FIG. 7 illustrates an example of signalling and operations for configuring polarization of cells at a communication network. Operations of FIG. 7 are described with further reference to FIG. 8, which illustrates an example of a trajectory of UE 110 from cell 130 served by gNB 120 to cell 132 served by gNB 122. UE 110 may be initially located within cell 130, for example at location “A” (FIG. 8). UE 110 may be initially in the idle mode or the connected mode. Cell 130 may be associated with a first cell identifier, e.g. PCI 1. Cell 132 may be associated with a second cell identifier, e.g. PCI 2. Operations of core network 140 may be performed by any suitable a network node or network function of core network 140. Operations of FIG. 7 may be also applied for configuring OAM modes at the cells, similar to configuration of polarization.

Even though some example embodiments have been described using two orthogonal polarizations as an example, it is understood that the example embodiments may be applied to more than two orthogonal polarizations (multi-polarization communication). For example, in case of linear polarization, there are generally three orthogonal polarizations (x, y, z), one in the direction of propagation and two polarizations perpendicular to the direction of propagation. However, reflections in the radio channel may cause the direction of propagation to change, thereby enabling also use of this third orthogonal polarization. However, example embodiments described with reference to multi-polarization communication may be also applied using dual-polarization communication.

Cell(s) may comprise a non-edge area, e.g. central area of the cell, which may be configured with dual-polarization transmission. Cell(s) may further comprise an edge area configured with single-polarization transmission. The polarizations associated with edge areas of adjacent cells may be orthogonal to each other. For example, single-polarization transmissions to the edge area of cell 130 may be provided with horizontal polarization and single-polarization transmissions to the edge area of cell 132 may be provided with vertical polarization. Dual-polarization transmissions to the non-edge areas may be transmitted with both of these polarizations, for example as MIMO-coded transmissions or with transmit diversity, as explained with reference FIG. 5. It is noted that in case of a non-omnidirectional radiation pattern, for example when applying beamforming, there may be more than one edge area for a cell, contrary to the example of FIG. 8. Same signal may be transmitted to both the edge and non-edge areas in the sense that data content may be the same for both areas. However, the signal may be differently coded for different areas, e.g. considering MIMO.

The non-edge and edge areas may be implemented for example by applying different vertical antenna tilts for the single- and dual-polarized signals. The different antenna tilts may be implemented electrically, for example by adjusting delays of signals provided to elements of an antenna array. In this case, multiple antenna elements may be configured to transmit the same signal. The signals may be configured to be combined in the air such that the composite signal is reinforced at a specific directions towards the non-edge or edge area. In one example, signals may be transmitted with a first polarization to both the edge and non-edge areas. Signals may be further transmitted to the non-edge area with a second polarization substantially orthogonal to the first polarization. At an adjacent cell, signals may be transmitted with the second polarization to both the edge and non-edge areas and further transmitted to the non-edge area with the first polarization.

If a cell is configured with non-edge area(s) and edge area(s), configured with single-polarization communication and multi-polarization communication, respectively, the single polarizations at the edge areas of a substantially linear pattern of cells may be arranged as follows. Referring to FIG. 6, a first polarization (H) may be configured for single-polarization communication at edge area(s) of cell 130. A second polarization (V) may be configured for single-polarization communication at edge area(s) of cell 132. The first polarization (H) may be configured for single-polarization communication at edge area(s) cell 134. At each cell, multiple polarizations (e.g. H+V) may be configured for multi-polarization communication at their non-edge area(s).

It is however noted that cells 130 and 132 may be also configured without dual-polarized transmissions. In that case, gNBs 120, 122 may transmit signals with a single polarization to the entire coverage area of the respective cell. A cell may be configured by default with single-polarization transmission over the entire coverage area. The dual-polarized non-edge area may be however provided to increase capacity close to gNB(s) 120, 122. This polarization adaptation within a cell may be applied for optimizing transmission capacity, in addition or as an alternative to link adaptation, where the modulation and/or coding scheme (MSC) may be adapted based on radio link conditions for a particular UE. Modulation may refer to using a particular constellation (e.g. quadrature amplitude modulation, QAM, constellation) for mapping binary data to real and/or imaginary parts of real or complex-valued modulation symbols. Coding scheme may refer to a type and/or a code rate of a FEC code. Therefore, in addition to selecting an antenna configuration for single-polarized or dual-polarized transmissions, also the modulation and/or coding scheme of UE 110 may be dependent on the received signal strength. UE 110 may for example configure its modulation and/or code rate based on signalling information received from gNB 120, which may select the modulation and/or code rate based on radio link conditions between UE 110 and gNB 120.

Referring back to FIG. 7, at operation 701 gNB 120 may receive, from core network 140, a configuration of a horizontal polarization (cf. first polarization). This polarization configuration may be targeted for single-polarization transmission at cell 130. The polarization configuration may be provided as any suitable control message(s) or signal(s) indicative of the polarization. The polarization configuration may further comprise an indication of whether single-polarization transmission is configured for the entire coverage area of cell 130, or, only for the edge area. The polarization configuration may further comprise an indication of whether dual-polarization transmission is configured for a non-edge area of cell 130. Core network 140 may also provide the polarization configuration (e.g. V) of cell 132 (PCI 2) to gNB 120, optionally along with polarization configurations of other cells of the network.

At operation 702, gNB 120 may select a first antenna configuration, for example in response to receiving the polarization configuration from core network 140. The first antenna configuration may be configured for transmission with a single polarization, in this example the horizontal polarization. Selection of antenna configuration may comprise selecting one of a plurality of fixed antenna configurations, where different antenna configurations are associated with different polarizations. The gNB 120 may therefore select the first antenna configuration based on a fixed mapping (e.g. stored at gNB 120) between the first antenna configuration and the indicated polarization. Alternatively, selection of an antenna configuration may comprise modifying the antenna configuration of gNB 120 to adapt the antenna configuration to the indicated polarization, for example by physically moving one or more antenna elements.

If cell 130 is configured with dual-polarization transmission at the non-edge area, gNB 120 may apply the polarization indicated at operation 701 to single-polarization transmissions to the edge area of cell 130. The first antenna configuration may therefore comprise a first antenna tilt configured to direct signal(s) from gNB 120 to edge area(s) of cell 130. The gNB 120 may further select a second antenna configuration for dual-polarization transmission. The second antenna configuration may be used for transmitting with both the horizontal and the vertical polarization (second polarization). The second antenna configuration may comprise a second (steeper) antenna tilt configured to direct signal(s) from gNB 120 to non-edge area(s) of cell 130.

At operation 703, gNB 122 may receive, from core network 140, a configuration of a vertical polarization (cf. second polarization) for single-polarization transmission at cell 132. Operation 703 may be performed similar to operation 701. Core network 140 may also provide the polarization configuration (e.g. H) of cell 130 (PCI 1) to gNB 122, optionally along with polarization configurations of other cells of the network.

At operation 704, gNB 120 may select a first antenna configuration, for example as described with reference to operation 702. The selection of antenna configuration may be in response to receiving the polarization configuration from core network 140. In this example, the first antenna configuration of gNB 122 is configured for transmission with vertical polarization. Similar to operation 704, first and second antenna configurations may be configured at gNB 122 for single and dual-polarization transmissions to the edge and non-edge area(s) of cell 132, respectively.

At operation 705, gNB 120 may transmit indications of the polarizations configured for single-polarization transmissions at cells 130 and 132, for example as part of the system information. The indications may be provided for example as a list of cells (identified for example by PCIs) associated with respective indications of polarizations for the cells. The list of cells may comprise polarizations for at least cell 130 as the serving cell of UE 110 and cell 132 as an adjacent cell of the serving cell 130. Optionally, polarizations for other cells of the network may be also indicated. System information may therefore comprise indications of polarization for the serving cell, from which UE 110 receives the system information, as well as for one or more other cells.

UE 110 may receive the indications of the polarizations, for example at location “A” (FIG. 8). UE 110 may be therefore within the edge area of cell 130 configured for single-polarization transmission by gNB 120. Note that if no dual-polarization transmission is configured for cell 130, UE 110 is within a single-polarization region regardless of its location within cell 130. UE 110 may be configured to initially receive signals (e.g. the system information) with an antenna configuration configured for dual-polarization reception with two orthogonal polarizations (e.g. horizontal and vertical). This antenna configuration may be referred to as a second antenna configuration of UE 110. This enables to acquire the information about the polarization applied for single-polarization transmissions at cell 130. Note that even if the use of both polarizations may cause additional interference, the system information may be still correctly received by UE 110 since the system information transmitted with a modulation and coding scheme (MCS) that enables successful decoding of the received signal.

The polarization configuration signalled at operation 705, for example as part of the system information, may further comprise a condition for applying, by UE(s), a single-polarization antenna configuration or a dual-polarization antenna configuration for reception of signals at cell 130. This polarization condition may be also applicable to other cell(s) of the network. The system information may identify the cells (e.g. by PCI) for which the condition is valid. Alternatively, conditions may be provided separately for different cells. UE 110 may receive the condition from gNB 120, for example as part of the system information.

The polarization condition may comprise a threshold for received signal strength, for example in terms of carrier-to-interference ratio (CIR), signal-to-interference-plus-noise ratio (SINR), reference signal received power (RSRP), or the like. UE 110 may use this threshold for determining whether to use single or dual polarization for reception, as will be further described with reference to operation 706. Effectively this enables gNB 120 to signal the border between the edge and non-edge areas of cell 130 and/or other cells. Setting the threshold in terms of received signal strength enables to improve transmission capacity at the bad reception areas between cells, while also benefiting from the high capacity enabled by the orthogonal transmission channels (e.g. using MIMO) close to the respective gNB.

The polarization condition may be transmitted with or without indicating which of the orthogonal polarizations (e.g. horizontal or vertical) is configured at cell 130 or cell 132. UE 110 may perform measurements with different polarizations and select a polarization or an antenna configuration based on the measurements, for example the polarization or antenna configuration providing the highest received signal strength. It is also possible that the polarization condition transmitted by gNB 120 indicates a condition for applying single-polarization communication or dual-polarization communication at cell 130. This may be done without indicating which of the polarizations is configured for single-polarization communication. Selection of the appropriate polarization may be performed at UE 110 based on received signal strength of cell 130 (e.g. with respect to cell 132).

At operation 706, UE 110 may configure its antenna polarization based on the indicated polarization configuration for cell 130. UE 110 may select a first antenna configuration for single-polarization reception with the horizontal polarization and receive signal(s) from the cell 130 with the first antenna configuration. Selection of UE's antenna polarization may be based on a fixed mapping between the antenna configuration and the indicated polarization, or, based on measurements, as will be further described with reference to FIG. 9 and FIG. 10.

If single-polarization transmission is configured over the entire coverage area of cell 130, UE 110 may use the first antenna configuration when it moves within cell 130, for example via locations “A” to “D” (FIG. 8). In that case, UE 110 may select the first antenna configuration independent of the received signal strength.

However, if dual-polarization transmission is configured for the non-edge area of cell 130, UE 110 may select the first antenna configuration, in response to determining that received signal strength from cell 130 (e.g. gNB 120) does not exceed the threshold indicated at operation 705 (as polarization condition). On the other hand, UE 110 may select a second antenna configuration configured for dual-polarization reception with both polarizations, in response to determining that the received signal strength from cell 130 exceeds the threshold. For example, at location “B” UE 110 may determine that the received signal strength has increased over the threshold and select the second antenna configuration. UE 110 may then apply the second antenna configuration for reception of signals from cell 130, for example when moving between locations “B” and “C”. UE 110 may monitor the received signal strength as it moves within cell 130. At location “C”, UE 110 may determine that the received signal strength from cell 130 has decreased below the threshold and switch to the first antenna configuration for receiving signals with a single polarization (horizontal) at the edge area of cell 130. The threshold associated with the polarization condition for using either single or dual-polarization may be referred to as a first threshold.

When operating the network without indicating the polarization condition (e.g. the threshold for single/multi-polarization communication), UE 110 may autonomously determine whether to communicate with gNB 120 using a single polarization or multiple polarizations. In one example, the polarization condition may be pre-configured (e.g. hardcoded) at UE 110. UE 110 may select to use single-polarization communication (e.g. with respective antenna configuration), if the received signal strength of the first cell does not exceed the threshold. UE 110 may select to use multi-polarization communication (e.g. with another antenna configuration), if the received signal strength of the first cell exceeds the threshold. If desired, UE 110 may receive signal(s) with multiple polarizations also in case of single-polarization communication. However, UE 110 may transmit at the uplink with the determined single polarization, in order to reduce interference between polarizations.

In another example, UE 110 may report results of received signal strength measurements to gNB 120. As noted above, the received signal strength may be measured for example in terms of CIR. SINR, or RSRP. The received signal strength may be therefore measured by signal(s) received from gNB 120, optionally considering also the interference from other gNBs.

When gNB 120 receives the indication of the received signal strength from UE 110, gNB 120 may determine, based on the received indication, whether to transmit or receive signal(s) to/from UE 110 using single or multi-polarization (e.g. with corresponding antenna configuration). For example, gNB 120 may transmit to UE 110 a request for single-polarization communication at cell 130, if the received signal strength reported by UE 110 docs not exceed the threshold. On the other hand, gNB 120 may transmit to UE 110 a request for multi-polarization communication at cell 130, if the received signal strength reported by UE 110 exceeds the threshold. The threshold may be pre-configured at gNB 120 or the threshold may be received from core network 140. UE 110 may select to use single/multi-polarization communication based on the request from gNB 120.

This enables the network to control use of different polarizations configurations (single/multi) at cell 130. This may be applied for example in case of beam steering (beamforming), where gNB 120 may transmit or receive signal(s) to/from UE 110 using single- or multi-polarization communication with a beam directed towards UE 110. This may be beneficial, since the coverage areas of single/multi-polarization communication may be individually selected for UEs, which may enable to improve overall throughput. For example, MIMO-coded data may be transmitted or received with multi-polarization communication at the non-edge area of cell 130.

If UE 110 communicates with gNB 120 via external antenna device 112, UE 110 may configure external antenna device 112 to apply a desired polarization, for example by transmitting an indication of the desired polarization to external antenna device 112. UE 110 may then perform the received signal strength measurements for different polarizations applied at external antenna device 112. UE 110 may transmit an indication of selected polarization(s) to external antenna device 112, in order to enable single-polarization or multi-polarization communication via the external antenna device using the selected polarization(s).

An antenna configuration may comprise any configuration of antenna(s), or mechanical or electrical elements/components associated with the antenna(s), that cause the transmitted radio signal to be polarized in a certain way. For example, the antenna configuration may comprise feeding the signal(s) to antenna element(s) having a particular orientation, or, for example in case of microstrip or patch antennas, feeding the antenna at a particular point. In general, UE 110 or gNBs 120, 122 may be configured to transmit and/or receive signals with particular polarizations, for example a single polarization (e.g. horizontal) or multiple polarizations (e.g. horizontal and vertical). Transmission with at least one antenna may comprise transmission with one or a plurality of antennas, or one or more of a plurality of antennas at a time. For example, UE 110 or gNB 120 may be equipped with multiple antennas and any of them (or any combination of them) may be configured for transmission of signal(s) with desired polarization(s).

Referring again to FIG. 7, at operation 707 data may be communicated between UE 110 and gNB 120, using either the horizontal polarization or both horizontal and vertical polarizations, optionally depending on the location of UE 110 within cell 130 if dual-polarization transmission has been configured for the non-edge area of cell 130. UE 110 may transmit data to gNB 120 and/or receive data from gNB 120 using the selected antenna configuration. If the UE 110 operates as a relay, for example in a mesh network architecture, UE 110 may relay the data between gNB 120 and another device.

At operation 708, UE 110 may perform cell re-selection (e.g. in idle mode) or handover (e.g. in connected mode) from cell 130 (PCI 1) to cell 132 (PCI 2). The gNBs 120, 122 and core network 140 may also take part in these processes, but their operations have not been depicted for simplicity. For example, at location “D” (FIG. 8) UE 110 may determine that the received signal strength from cell 130 has decreased below or equal to a second threshold. This threshold may be called a handover threshold or a cell re-selection threshold. In response, UE 110 may switch to the second antenna configuration (both polarizations). UE 110 may then continue reception of (horizontally polarized) signal(s) from cell 130 with the second antenna configuration. At the same time, UE 110 may perform neighbour cell measurements with the second antenna configuration. Applying the second antenna configuration enables UE 110 to detect also (vertically polarized) signals from cell 132. UE 110 may then perform cell re-selection or handover to cell 130 based on the neighbour cell measurements, for example when the received signal strength of cell 132 exceeds the received signal strength of cell 130.

The first threshold may be higher than the second threshold. This enables to ensure that there exists an edge area with single-polarization transmission. The offset between the two thresholds may be adjusted to control the width of the edge area. One or both of the thresholds may be signalled to UE 110 by gNB 120. This enables dynamic configuration of the edge and non-edge areas within cell 130. The gNB 120 may receive the threshold(s) from the core network 140.

In general, UE 110 may switch to the single-polarization or single-OAM mode communication with the second polarization, in response to performing cell re-selection or handover, for example from cell 130 to cell 132. UE 110 may enable communication with the second polarization, for example in response to detecting the received signal strength from cell 130 to decrease below or equal to the second threshold. UE 110 may perform neighbour cell measurements with the second polarization or OAM mode and perform the cell re-selection or the handover to the cell 132 based on the neighbour cell measurements. However, while performing the neighbour cell measurements, UE 110 may continue transmission or reception of signal(s) to/from cell 130 with the first polarization or OAM mode. Alternatively, UE 110 may transmit an indication of the first and second polarizations or OAM modes to the external antenna device 112 to continue transmission or reception of the signal(s) from cell 130 (e.g. while performing the neighbour cell measurements with the second polarization).

UE 110 may perform a hard handover, where payload data or user data (e.g. data of application(s) running on UE 110) may be communicated either via cell 130 or cell 132. UE 110 may be connected to one cell at a time. In this case, data may be communicated using single-polarization or single-OAM mode at either cell 130 or cell 132. UE 110 may however use the other polarization for handover measurements. UE 110 may alternatively perform a soft handover, where UE 110 may be connected to more than one cell (e.g. cell 130 and cell 132) at the same time. In this case, data may be communicated using a single polarization or a single OAM mode at both (or multiple) cells with respective substantially orthogonal polarizations. When performing the handover, UE 110 may be located at edge areas of the cells.

At operation 709, UE 110 may configure its antenna polarization based on the indicated polarization configurations for cell 132, similar to operation 706. UE 110 may for example switch to an antenna configuration configured for single-polarization reception with the vertical polarization (cf. second polarization). This antenna configuration may be referred to as a third antenna configuration of UE 110. Switching to the third antenna configuration may be in response to performing the cell re-selection or handover to cell 132. UE 110 may then receive (vertically polarized) signal(s) from cell 132 with the third antenna configuration. Similar to operation 706, selection between the third antenna configuration (single-polarization reception) and the second antenna configuration (both polarizations) may be optionally based on the received signal strength and the first threshold, i.e., whether UE 110 is within the edge area or non-edge area of cell 132.

At operation 710, data may be communicated between UE 110 and gNB 122, using either the vertical polarization or both horizontal and vertical polarizations, optionally depending on the location of UE 110 within cell 132 and if dual-polarization transmission has been configured for the non-edge area of cell 132. UE 110 may transmit data to gNB 122 and/or receive data from gNB 122 using the selected antenna configuration. Operation 710 may be otherwise similar to operation 707.

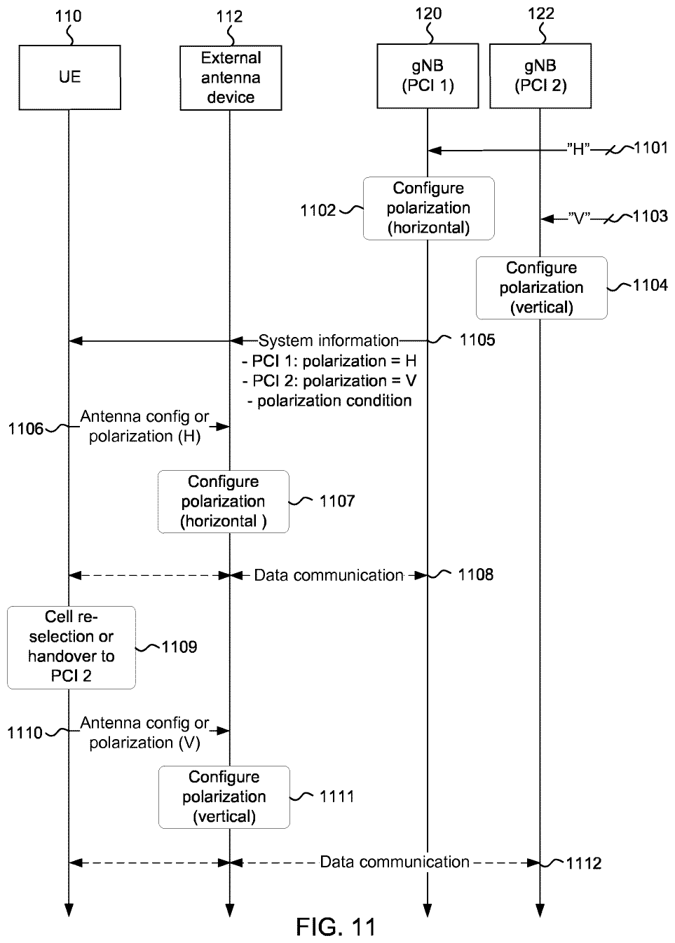

FIG. 9 illustrates an example of a method for selecting antenna configuration based on polarization or OAM mode. Operation 901 may be used to implement operation 706 or 709. UE 110 or external antenna device 112 may be configured with different antenna configurations, which enable reception of signals with particular polarization(s). If orientation of the antenna(s) is substantially fixed with respect to the transmit antenna(s) of the cell, each antenna configuration may be mapped to a particular polarization configuration. This may be the case for example if UE 110 or external antenna device 112 is fixedly coupled to a stationary or mobile platform, e.g. a vehicle or a body part of a user (e.g. ear). UE 110 or external antenna device 112 may be for example preconfigured with a look-up table comprising a mapping between antenna configurations and polarizations. When receiving the indication of the configured polarization, UE 110, or external antenna device 112, may select the antenna configuration based on the fixed mapping. It is noted that in some embodiments UE 110 may select an antenna configuration for external antenna device 112. In this case, external antenna device 112 may provide the mapping between its antenna configurations and the polarizations to UE 110, as will be further described with reference to FIG. 11. UE 110 may apply the selected antenna configuration for reception of and/or transmission of signals. Operation 901 may be also applied for selecting an antenna configuration for different OAM modes, similar to the selection based on polarization.

FIG. 10 illustrates an example of a method for selecting antenna configuration based on measurements. Operations 1001 and 1002 may be used to implement operation 706 or 709. Alternative to the fixed mapping of operation 901, UE 110, or external antenna device 112, may select the desired antenna configuration for certain polarization configuration based on measurements. This may be useful in example embodiments where orientation of UE 110 or external antenna device 112 is susceptible to change with respect to the transmit antenna(s) of the cell.

At operation 1001, UE 110 or external antenna device 112 may measure received signal strength with both polarizations, for example in terms of carrier-to-interference ratio (CIR), signal-to-interference-plus-noise ratio (SINR), reference signal received power (RSRP), or the like. Received signal strength from cell 130 (gNB 120) may be measured separately with the first antenna configuration (e.g. horizontal polarization) and the third antenna configuration (e.g. vertical polarization). Alternatively, or additionally, UE 110 may measure its orientation, for example by a gyroscope and/or compass.

At operation 1002, UE 110 or external antenna device 112 may select an antenna configuration based on the measurements. For example, the first antenna configuration may be selected, in response to determining that the received signal strength measured with the first antenna configuration exceeds the received signal strength measured with the third antenna configuration. The measurements may be performed periodically or with a schedule of irregular intervals, for example in order to adapt the antenna configuration to changes in orientation of either device.

If UE 110 communicates with gNB 120 or 122 via external antenna device 112, UE 110 may request external antenna device 112 to configure itself with the first or third antenna configuration, for example in order to enable UE 110 to perform the measurements. The measurements may be performed sequentially, e.g. one antenna configuration at a time. The measurement based selection of antenna configuration enables the desired antenna configuration to be selected, even of the orientation of UE 110 or external antenna device 112 changes.

If UE 110 measures its orientation, it may select the first antenna configuration based on the measured orientation and the first polarization or OAM mode. For example, UE 110 may be preconfigured with a mapping (e.g. look-up table) between polarizations (or OAMs), orientations, and antenna configurations. Based on the measured orientation, UE 110 may select the antenna configuration that corresponds, or is closest, to the desired polarization or OAM. Operations 1001 and 1002 may be also applied for selecting an antenna configuration from a plurality of antenna configurations configured for different OAM modes.

In general, UE 110 may select, based on measurements (e.g. received signal strength), which polarization to use for single-polarization communication. UE 110 may for example select to communicate with the first polarization at cell 130 (e.g. at the edge area of cell 130), if the received signal strength using the first polarization is higher than the signal strength using the second polarization. When performing handover to cell 132, UE 110 may start using the second polarization for single-polarization communication at cell 132. This may be based on pre-configured information about adjacent cells being configured with orthogonal polarizations, and/or, performing the measurements again for both polarizations.

FIG. 11 illustrates an example of signalling and operations for configuring polarization of cells at a communication network, when a UE communicates via an external antenna device. Operations of FIG. 11 may be also applied for configuring OAM modes at the cells, similar to configuration of polarization.

At operations 1101, 1102, 1102, and 1104, gNBs 120, 122 may receive indications of the polarizations configured for single-polarization transmissions at respective cells 130, 132 and select their antenna configurations accordingly, similar to operations 701 to 704.

At operation 1105, gNB 120 may transmit indications of the polarizations configured for single-polarization transmissions at cells 130 and 132, optionally with the polarization condition, similar to operation 705. External antenna device 112 may receive this information and forward it to UE 110. As already noted above, external antenna device 112 may further transmit an indication of a fixed mapping (e.g. a look-up table) between polarizations and antenna configurations of external antenna device 112 to UE 110. In this case, UE 110 may select, based on the mapping indicated by external antenna device 112, an antenna configuration for external antenna device 112 for the indicated polarization (horizontal in this example).

At operation 1106, UE 110 may transmit an indication of the selected antenna configuration (e.g. first antenna configuration) to external antenna device 112. Alternatively, UE 110 may transmit an indication of polarization to external antenna device 112. Routing this signaling via UE 110 enables to implement external antenna device 112 as a low-complex repeater without ability to decode signals received from gNB 120, for example the system information. In this case, the interface between UE 110 and external antenna device 112 may be implemented by any suitable wired or wireless communication interface, which may be less complex compared to the cellular protocol used by gNB 120.

At operation 1107, external antenna device 112 may configure its antenna configuration based on the indication received from UE 110 at operation 1106 (antenna configuration or polarization). Alternatively, external antenna device 112 may extract the relevant signalling information from the signal provided by gNB 120 and at least initially select its antenna configuration independent of UE 110. In this case, external antenna device 112 may not forward the signal or information received from gNB 120 to UE 110.

At operation 1108, data may be communicated between gNB 120 and UE 110, similar to operation 707. However, data communication between gNB 120 and UE 110 may be via external antenna device 112. UE 110 may for example receive signal(s) from cell 130 via external antenna device 112. UE 110 may also transmit signal(s) to gNB120 via external antenna device 112.

At operation 1109, UE 110 may perform cell re-selection or handover from cell 130 (PCI 1) to cell 132 (PCI 2), similar to operation 708. However, instead of reconfiguring its own antenna configuration, UE 110 may transmit an indication of the second antenna configuration (configured for both polarizations) or an indication of both polarizations to external antenna device 112, for example to enable neighbouring cell measurements, as described with reference to operation 708. External antenna device 112 may reconfigure its antenna configuration based on the received indication.

At operation 1110, for example once the cell-reselection or handover has been performed, UE 110 may transmit an indication of the third antenna configuration (configured for vertical polarization in this example) or an indication of the vertical polarization to external antenna device 112.

At operation 1111, external antenna device 112 may configure its antenna configuration based on the indication received from UE 110 at operation 1106, or independent of UE 110, similar to operation 1107.

At operation 1112, data may be communicated between gNB 120 and UE 110, similar to operation 1108. However, external antenna device 112 may be configured for reception and/or transmission of vertically polarized signals.

It is further noted that, the embodiments related to the non-edge and edge areas of cell 130 or 132 may be also applied when UE 110 communicates via external antenna device 112. Instead of configuring its own antenna configuration, UE 110 may transmit indication(s) of the desired antenna configuration(s) and/or polarization(s) to external antenna device 112, for example as UE 110 moves along the trajectory of FIG. 8.

Example embodiments therefore enable use of different polarization configurations at adjacent cells and/or within a single cell, for example in order to improve transmission capacity in LOS conditions at the radio channel.

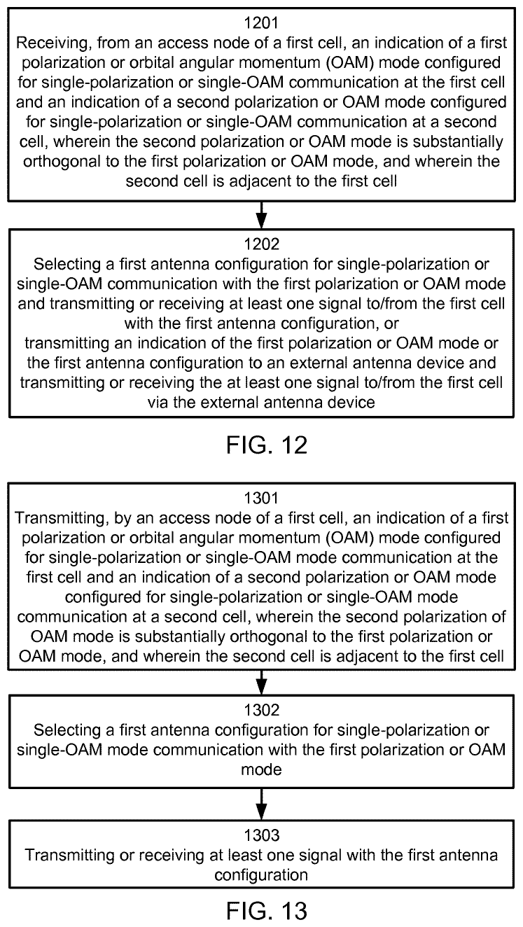

FIG. 12 illustrates an example of a method for selecting antenna configuration, polarization, or OAM mode.

At 1201, the method may comprise receiving, from an access node of a first cell, an indication of a first polarization or orbital angular momentum (OAM) mode configured for single-polarization or single-OAM communication at the first cell and an indication of a second polarization or OAM mode configured for single-polarization or single-OAM communication at a second cell, wherein the second polarization or OAM mode is substantially orthogonal to the first polarization or OAM mode, and wherein the second cell is adjacent to the first cell.

At 1202, the method may comprise selecting a first antenna configuration for single-polarization or single-OAM communication with the first polarization or OAM mode and transmitting or receiving at least one signal to/from the first cell with the first antenna configuration, or transmitting an indication of the first polarization or OAM mode or the first antenna configuration to an external antenna device and transmitting or receiving the at least one signal to/from the first cell via the external antenna device.

FIG. 13 illustrates an example of a method for configuring polarization or OAM mode of a cell.

At 1301, the method may comprise transmitting, by an access node of a first cell, an indication of a first polarization or orbital angular momentum (OAM) mode configured for single-polarization or single-OAM mode communication at the first cell and an indication of a second polarization or OAM mode configured for single-polarization or single-OAM mode communication at a second cell, wherein the second polarization of OAM mode is substantially orthogonal to the first polarization or OAM mode, and wherein the second cell is adjacent to the first cell.

At 1302, the method may comprise selecting a first antenna configuration for single-polarization or single-OAM mode communication with the first polarization or OAM mode.

At 1303, the method may comprise transmitting or receiving at least one signal with the first antenna configuration.

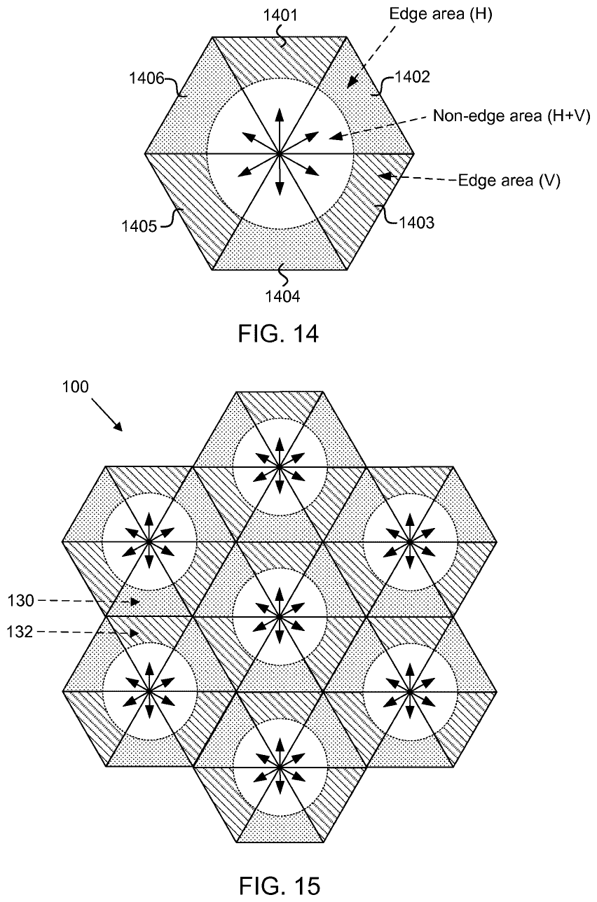

FIG. 14 illustrates an example of a site with six sectors. Each of the sectors 1401 to 1406 may comprise a cell. One or more non-edge areas of the sectors 1401 to 1406, included within the white circle, may be configured with multi-polarization or multi-OAM communication. Edge areas of the sectors 1401 to 1406 may be configured with single-polarization or single-OAM communication. Adjacent sectors, for example sectors 1402 and 1403 may be configured with substantially orthogonal polarizations or OAM modes. For example, sectors 1402 and 1403 may be configured with horizontal (dotted) and vertical (dashed) polarizations, respectively. An edge area may comprise an area at a border of cells (e.g. sectors) of different sites. A non-edge area may comprise an area that is located at a distance from border(s) of cells of different sites.

FIG. 15 illustrates an example of a hexagonal six-sectored network topology. Sectors of different sites of communication network 100 may be arranged such that sectors pointing towards each other are configured with orthogonal polarizations or OAM-mode. This enables single-polarization communication at the edge areas without significant interference from neighboring site(s). Considering this type of network topology, cell 130 may be associated with (e.g. served by/from) a first site of the radio access network (RAN). Cell 132 may be associated with a second site of the RAN. Cells 130 and 132 may be configured to point towards each other (towards the other site) and therefore they may be configured with orthogonal polarizations. In general, communication network 100 may comprise plurality of sites, wherein edge areas of opposite sectors (cells) of adjacent sites are configured with substantially orthogonal polarizations or OAM-modes. Similar approach may be applied also for other number of sectors, for example twelve sectors. The number of sectors may be for example an even number divisible by six.

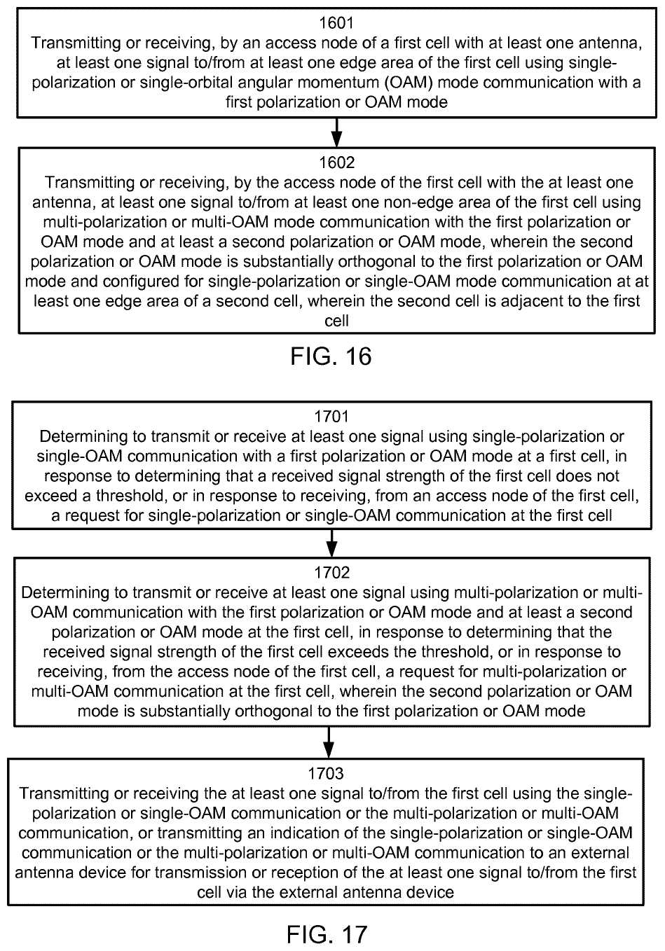

FIG. 16 illustrates an example of communication with a device located at an edge area or a non-edge areas of a cell.

At 1601, the method may comprise transmitting or receiving, by an access node of a first cell with at least one antenna, at least one signal to/from at least one edge area of the first cell using single-polarization or single-orbital angular momentum (OAM) mode communication with a first polarization or OAM mode.

At 1602, the method may comprise transmitting or receiving, by the access node of the first cell with the at least one antenna, at least one signal to/from at least one non-edge area of the first cell using multi-polarization or multi-OAM mode communication with the first polarization or OAM mode and at least a second polarization or OAM mode, wherein the second polarization or OAM mode is substantially orthogonal to the first polarization or OAM mode and configured for single-polarization or single-OAM mode communication at at least one edge area of a second cell, wherein the second cell is adjacent to the first cell.

FIG. 17 illustrates an example of a method for communication at an edge area or a non-edge area of a cell.

At 1701, the method may comprise determining to transmit or receive at least one signal using single-polarization or single-OAM communication with a first polarization or OAM mode at a first cell, in response to determining that a received signal strength of the first cell does not exceed a threshold, or in response to receiving, from an access node of the first cell, a request for single-polarization or single-OAM communication at the first cell.

At 1702, the method may comprise determining to transmit or receive at least one signal using multi-polarization or multi-OAM communication with the first polarization or OAM mode and at least a second polarization or OAM mode at the first cell, in response to determining that the received signal strength of the first cell exceeds the threshold, or in response to receiving, from the access node of the first cell, a request for multi-polarization or multi-OAM communication at the first cell, wherein the second polarization or OAM mode is substantially orthogonal to the first polarization or OAM mode.

At 1703, the method may comprise transmitting or receiving the at least one signal to/from the first cell using the single-polarization or single-OAM communication or the multi-polarization or multi-OAM communication, or transmitting an indication of the single-polarization or single-OAM communication or the multi-polarization or multi-OAM communication to an external antenna device for transmission or reception of the at least one signal to/from the first cell via the external antenna device.

Further features of the methods directly result from the functionalities and parameters of the UE 110, gNB 120, 122, and/or external antenna device 112, or in general apparatus 200, as described in the appended claims and throughout the specification, and are therefore not repeated here. Different variations of the methods may be also applied, as described in connection with the various example embodiments.

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a description of the structure and use of example embodiments. Although various embodiments have been described above with a certain degree of particularity, or with reference to one or more individual embodiments, those skilled in the art could make numerous alterations to the disclosed embodiments without departing from scope of this specification.

1. An apparatus, comprising:
at least one processor; and
at least one memory including computer program code; the at least one memory and the computer program code configured to, with the at least one processor, cause the apparatus at least to:
transmit or receive, by an access node of a first cell with at least one antenna, at least one signal to/from at least one edge area of the first cell using single-polarization or single-orbital angular momentum (OAM) mode communication with a first polarization or OAM mode; and
transmit or receive, by the access node of the first cell with the at least one antenna, at least one signal to/from at least one non-edge area of the first cell using multi-polarization or multi-OAM mode communication with the first polarization or OAM mode and at least a second polarization or OAM mode, wherein the second polarization or OAM mode is substantially orthogonal to the first polarization or OAM mode and configured for single-polarization or single-OAM mode communication at at least one edge area of a second cell, wherein the second cell is adjacent to the first cell.

2. The apparatus according to claim 1, wherein the at least one memory and the computer program code are further configured to, with the at least one processor, cause the apparatus to:
transmit, to a device, a condition for applying single-polarization or single-OAM mode communication or multi-polarization or multi-OAM mode communication at least at the first cell, wherein the condition comprises a threshold for a received signal strength.

3. The apparatus according to claim 1, wherein the at least one memory and the computer program code are further configured to, with the at least one processor, cause the apparatus to:
receive, from a device, an indication of a received signal strength; and
determine to transmit or receive the at least one signal to/from the device using the multi-polarization or multi-OAM mode communication, in response to determining that the received signal strength exceeds a threshold.

4. The apparatus according to claim 3, wherein the at least one memory and the computer program code are further configured to, with the at least one processor, cause the apparatus to:
transmit or receive the at least one signal using the single-polarization or single-OAM mode communication or the multi-polarization or multi-OAM mode communication with a beam directed towards the device.

5. The apparatus according to claim 1 wherein the at least one memory and the computer program code are further configured to, with the at least one processor, cause the apparatus to:
transmit or receive the at least one signal with the single-polarization or single-OAM mode communication using a first antenna configuration, wherein the first antenna configuration comprises a first antenna tilt configured to direct the at least one signal to the at least one edge area of the first cell; and
transmit or receive the at least one signal with the multi-polarization or multi-OAM mode communication using a second antenna configuration, wherein the second antenna configuration comprises a second antenna tilt configured to direct the at least one signal to the at least one non-edge area of the first cell.

6. The apparatus according to claim 2, wherein the received signal strength comprises a carrier-to-interference ratio, a signal-to-interference-plus-noise ratio, or a reference signal received power of the first cell.

7. The apparatus according to claim 1, wherein the first polarization or OAM mode is configured for single-polarization or single-OAM mode communication at at least one edge area of a third cell, wherein the third cell is adjacent to the second cell, and wherein the first cell, the second cell, and the third cell are located in a substantially linear pattern.

8. An apparatus, comprising:
at least one processor; and
at least one memory including computer program code; the at least one memory and the computer program code configured to, with the at least one processor, cause the apparatus at least to:
determine to transmit or receive at least one signal using single-polarization or single-OAM communication with a first polarization or OAM mode at a first cell, in response to determining that a received signal strength of the first cell does not exceed a threshold, or in response to receiving, from an access node of the first cell, a request for single-polarization or single-OAM communication at the first cell;
determine to transmit or receive at least one signal using multi-polarization or multi-OAM communication with the first polarization or OAM mode and at least a second polarization or OAM mode at the first cell, in response to determining that the received signal strength of the first cell exceeds the threshold, or in response to receiving, from the access node of the first cell, a request for multi-polarization or multi-OAM communication at the first cell, wherein the second polarization or OAM mode is substantially orthogonal to the first polarization or OAM mode; and
transmit or receive the at least one signal to/from the first cell using the single-polarization or single-OAM communication or the multi-polarization or multi-OAM communication, or
transmit an indication of the single-polarization or single-OAM communication or the multi-polarization or multi-OAM communication to an external antenna device for transmission or reception of the at least one signal to/from the first cell via the external antenna device.

9. The apparatus according to claim 8, wherein the second polarization or OAM mode is configured for single-polarization or single-OAM mode communication at at least one edge area of a second cell, wherein the second cell is adjacent to the first cell.

10. The apparatus according to claim 8, wherein the threshold for the received signal strength is pre-configured at the apparatus.

11. The apparatus according to claim 8, wherein the at least one memory and the computer program code are further configured to, with the at least one processor, cause the apparatus to:
receive, from the access node of the first cell, a condition for using the single-polarization or single-OAM mode communication or the multi-polarization or multi-OAM communication at least at the first cell, wherein the condition comprises the threshold for the received signal strength.

12. The apparatus according to claim 8, wherein the at least one memory and the computer program code are further configured to, with the at least one processor, cause the apparatus to:
measure the received signal strength of the first cell; and
transmit an indication of the received signal strength of the first cell to the access node.

13. The apparatus according to claim 8, wherein the at least one memory and the computer program code are further configured to, with the at least one processor, cause the apparatus to:
select a first antenna configuration for the single-polarization or single-OAM communication with the first polarization or OAM mode based on received signal strength measurements of a plurality of antenna configurations configured for different polarizations or OAM modes.

14. A method, comprising:
transmitting or receiving, by an access node of a first cell with at least one antenna, at least one signal to/from at least one edge area of the first cell using single-polarization or single-orbital angular momentum (OAM) mode communication with a first polarization or OAM mode; and
transmitting or receiving, by the access node of the first cell with the at least one antenna, at least one signal to/from at least one non-edge area of the first cell using multi-polarization or multi-OAM mode communication with the first polarization or OAM mode and at least a second polarization or OAM mode, wherein the second polarization or OAM mode is substantially orthogonal to the first polarization or OAM mode and configured for single-polarization or single-OAM mode communication at at least one edge area of a second cell, wherein the second cell is adjacent to the first cell.

15. A method, comprising:
determining to transmit or receive at least one signal using single-polarization or single-OAM communication with a first polarization or OAM mode at a first cell, in response to determining that a received signal strength of the first cell does not exceed a threshold, or in response to receiving, from an access node of the first cell, a request for single-polarization or single-OAM communication at the first cell;
determining to transmit or receive at least one signal using multi-polarization or multi-OAM communication with the first polarization or OAM mode and at least a second polarization or OAM mode at the first cell, in response to determining that the received signal strength of the first cell exceeds the threshold, or in response to receiving, from the access node of the first cell, a request for multi-polarization or multi-OAM communication at the first cell, wherein the second polarization or OAM mode is substantially orthogonal to the first polarization or OAM mode; and
transmitting or receiving the at least one signal to/from the first cell using the single-polarization or single-OAM communication or the multi-polarization or multi-OAM communication, or
transmitting an indication of the single-polarization or single-OAM communication or the multi-polarization or multi-OAM communication to an external antenna device for transmission or reception of the at least one signal to/from the first cell via the external antenna device.
